(19) United States
(12) Patent Application Publication
(10) Pub. No.: US 2025/0387904 A1
(43) Pub. Date: Dec. 25, 2025

(54) TECHNIQUES FOR ROBOTIC ASSEMBLY USING SPECIALIST AND GENERALIST POLICIES

(71) Applicant: NVIDIA CORPORATION, Santa Clara, CA (US)

(72) Inventors: Bingjie TANG, Los Angeles, CA (US); Yashraj Shyam NARANG, Seattle, WA (US); Iretiayo AKINOLA, Seattle, WA (US); Dieter FOX, Seattle, WA (US); Ankur HANDA, Seattle, WA (US); Fabio TOZETO RAMOS, Seattle, WA (US); Bowen WEN, Bellevue, WA (US); Karl VAN WYK, Issaquah, WA (US); Jie XU, Bellevue, WA (US)

(21) Appl. No.: 19/096,085

(22) Filed: Mar. 31, 2025

Related U.S. Application Data
(60) Provisional application No. 63/664,120, filed on Jun. 25, 2024.

(51) Int. Cl. B25J 9/16

(52) U.S. Cl. CPC B25J 9/163

(57) ABSTRACT

The disclosed method for training a robot control model includes generating, using one or more simulations, a plurality of disassembly trajectories along which a first part is disassembled from a second part; reversing the plurality of disassembly trajectories to generate a plurality of reversed disassembly trajectories; and performing, based on the plurality of reversed disassembly trajectories, one or more operations to train an untrained machine learning model to generate a trained machine learning model, wherein the trained machine learning model is trained to control a robot to assemble the first part and the second part.

### CROSS-REFERENCE TO RELATED APPLICATIONS

This application claims priority benefit of the United States Provisional Patent Application titled, “REINFORCEMENT LEARNING TECHNIQUES FOR ROBOTIC ASSEMBLY,” filed on Jun. 25, 2024, and having Ser. No. 63/664,120. The subject matter of this related application is hereby incorporated herein by reference.

### BACKGROUND

### Technical Field

Embodiments of the present disclosure relate generally to computer science, artificial intelligence and machine learning, and robot control and, more specifically, to techniques for robotic assembly.

### Description of the Related Art

Robotic assembly refers to the use of automated systems, such as robots, for joining parts together, such as joining gears, circuit boards, panels, and/or the like. Robotic assembly tasks can include aligning parts, applying fasteners, inserting connectors in objects, and/or the like. In robotic assembly, a robot can use motion control algorithms and sensor data, such as force readings, camera images, and/or the like, to guide the movements of a tip of the robotic arm, known as the end-effector, so that parts are joined correctly. Robotic assembly systems can be deployed in assembly lines where each robot arm handles a specific step, such as attaching a door to a car frame or inserting a circuit board into a device housing. Robotic assembly systems can also be used in smaller-scale settings to handle precision tasks that require consistent, reliable part placement, such as miniature electronics assembly, watchmaking, medical device manufacturing, and/or the like.

Conventional approaches for robotic assembly oftentimes use predefined sequences and manually engineered pipelines to guide the joining of parts. Such approaches typically divide the assembling process into distinct modules for handling parts, aligning the parts, and inserting parts into other parts. The handling module positions each part using rigid fixtures or feeders designed for specific shapes and sizes. The alignment module calculates the required orientations or offsets between parts based on known reference points or fiducials. The insertion module then executes a prescribed motion, typically using a position-based or force-based control strategy, to bring the parts together. For example, conventional approaches for robotic assembly can rely on pre-measured tolerances and calibrated trajectories when inserting plugs, fasteners, or similar components. Such approaches have been widely adopted in manufacturing lines for assembly tasks, such as fastening subassemblies or stacking circuit boards, where a robot repeatedly makes the same series of movements.

One drawback of the above approaches for robotic assembly is the need for customized and predefined fixtures, tooling, and waypoints during the assembly process, which limits the applicability of these robotic assembly systems in high-mixture settings where the robot is required to assemble many different types of parts, each potentially varying in shape, size, and orientation. In high-mixture settings, the same assembly line may process multiple product models, or a single product may feature numerous component variations. For example, an automotive manufacturer could process multiple car models on the same assembly line, each requiring different bracket and fastener sizes, while an electronics assembly facility could produce a broad range of circuit boards and cable connectors, each with unique geometries and pin layouts. A robot configured to place one specific shape of a part at a fixed waypoint may struggle or require extensive reconfiguration when the robot is used to place differently sized or shaped parts.

As the foregoing illustrates, what is needed in the art are more effective techniques for robotic assembly.

### SUMMARY

According to some embodiments, a computer-implemented method for training a robot control model includes generating, using one or more simulations, a plurality of disassembly trajectories along which a first part is disassembled from a second part. The method further includes reversing the plurality of disassembly trajectories to generate a plurality of reversed disassembly trajectories. In addition, the method includes performing, based on the plurality of reversed disassembly trajectories, one or more operations to train an untrained machine learning model to generate a trained machine learning model, wherein the trained machine learning model is trained to control a robot to assemble the first part and the second part.

According to some embodiments, a computer-implemented method for training a machine learning model to control a robot. The method includes performing, based on demonstration data associated with one or more assembly tasks, one or more first training operations to generate one or more first trained machine learning models, wherein each first trained machine learning included in the one or more first trained machine learning models is trained to control a robot to perform a different assembly task. The method further includes performing, based on the one or more first trained machine learning models and one or more geometries associated with one or more parts, one or more second training operations to generate a second trained machine learning model, wherein the second trained machine learning model is trained to control the robot to perform a plurality of assembly tasks.

Further embodiments provide, among other things, non-transitory computer-readable storage media storing instructions and systems configured to implement the method set forth above.

At least one technical advantage of the disclosed techniques relative to the prior art is that the disclosed techniques enable robotic assembly in high-mixture settings where a robot is required to assemble many different types of parts, each potentially varying in shape, size, and orientation, and the disclosed techniques do not require customized fixtures, predefined tooling, or manually specified waypoints. Additionally, the disclosed techniques allow robots to dynamically adjust movements based on real-time part observations rather than adhering to rigid pre-programmed waypoints. The ability to adjust movements based on real-time part observations enables a single robotic assembly system to adapt to various product models and parts variations within the same production line, improving efficiency and reducing downtime associated with reconfiguring the robotic assembly system. These technical advantages provide one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, can be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 is a block diagram of a computer system configured to implement one or more aspects of various embodiments;

FIG. 2A is a more detailed illustration of the machine learning server of FIG. 1, according to various embodiments;

FIG. 2B is a more detailed illustration of the computing device of FIG. 1, according to various embodiments;

FIG. 3 is a more detailed illustration of the expert assembly data generator of FIG. 1, according to various embodiments;

FIG. 4A illustrates how the model trainer of FIG. 1 trains specialist actor models, according to various embodiments;

FIG. 4B illustrates how the model trainer of FIG. 1 trains a generalist actor model, according to various embodiments;

FIG. 4C illustrates how the model trainer of FIG. 1 re-trains the generalist actor model of FIG. 4B, according to various embodiments;

FIG. 5 is a more detailed illustration of the robot control application of FIG. 1, according to various embodiments;

FIG. 6 is a flow diagram of method steps for generating expert assembly data, according to various embodiments;

FIG. 7 is a flow diagram of method steps for training a generalist actor model, according to various embodiments;

FIG. 8 is a flow diagram of method steps for training specialist actor models, according to various embodiments;

FIG. 9A-9B are flow diagrams of method steps for training a generalist actor model using trained specialist actor models, according to various embodiments; and

FIG. 10 is the flow diagram of method steps for controlling a robot using a trained generalist actor model, according to various embodiments.

### DETAILED DESCRIPTION

In the following description, numerous specific details are set forth to provide a more thorough understanding of the various embodiments. However, it will be apparent to one skilled in the art that the concepts can be practiced without one or more of these specific details.

### General Overview

Embodiments of the present disclosure provide techniques for robotic assembly using specialist and generalist policies. In various embodiments, an expert assembly data generator processes part geometry data and generates expert assembly data for training the specialist policy models, and the trained specialist policies and (optionally) reinforcement learning are used to train the generalist policy model. The expert assembly data generator includes a part geometry data preparation module, an environment randomization module, a grasp sampling module, a disassembly trajectory generator, a trajectory reversion module, and a simulator. In order to generate the expert assembly data, the part geometry data preparation module processes part geometry data, which includes but is not limited to the meshes of multiple parts that are to be assembled, and the part geometry data preparation module generates processed part geometry data. The grasp sampling module interacts with the simulator and generates a grasp sample, which includes a feasible way for the robot end effector to grasp a part. The environment randomization module processes the grasp sample and generates a randomized assembly state. The simulator uses a robot model and a simulation environment to simulate a robotic disassembly task based on the randomized assembly state. A disassembly trajectory generator generates one or more disassembly trajectories, which include robot trajectories on how the robot disassembles the grasped part from another part, based on the grasp sample and the part assembly state in the simulator. Then, a trajectory reversion module reverses the disassembly trajectories.

In some embodiments, the expert assembly data is used to train specialist actor models, which are machine learning models trained to control a robot to perform specific robotic assembly tasks, that are in turn used to train a generalist actor model, which is a machine learning model that is trained to control a robot to perform multiple different robotic assembly tasks. The training is carried out in three stages. In the first stage of training, the simulator generates one or more specialist actor model observations. The specialist actor models process the specialist actor observations and generate specialist actor actions, which are applied to the simulator to generate new actor observations and critic observations. Specialist critic models, which are machine learning models, evaluate the specialist actor actions using the critic observations and generate critic evaluations. The simulator then generates roll-out data, which includes robot and parts states as well as specialist actor observations. A specialist reward calculator calculates a reward that includes a baseline reward and an imitation reward based on the roll-out data and expert assembly data. A reinforcement learning module then updates one or more parameters of the specialist actor models and specialist critic models based on the reward and specialist critic evaluations iteratively, until a stopping criterion is met. Once the specialist actor models are trained, the model trainer stores the trained specialist actor models to be used in the second stage. In the second stage of training, the trained specialist actor models process specialist actor observations from the simulator and generate specialist actor actions. The simulator processes the specialist actor actions and generates demonstration data. The simulator then uses the demonstration data to generate generalist actor observations. The generalist actor model processes part geometries and the generalist actor observations and generate generalist actor actions. A generalist loss calculator calculates a behavior cloning loss based on a difference between the specialist actor actions included in expert demonstration data and the generalist actor actions. The model trainer uses the behavior cloning loss to update one or more parameters of the generalist actor model until a stopping criterion is met. Once the training of the generalist actor model during the second stage is complete, the model trainer stores the trained generalist actor model to be re-trained in the third stage. In the third stage of the training, the trained generalist actor model processes generalist actor observations from the simulator to generate generalist actor actions. The simulator uses the generalist actor actions to generate specialist actor observations and (dataset aggregation) DAgger data. The trained specialist actor models process the specialist actor observations and generate specialist actor actions. The generalist loss calculator processes the specialist actor actions and the DAgger data to calculate a DAgger loss. The model trainer uses the DAgger loss to update one or more parameters of the trained generalist actor model iteratively until a stopping criterion is met. In some embodiments, the model trainer optionally further re-trains the trained generalist actor model using reinforcement learning. Subsequent to training, the trained generalist actor model can be used to process part geometries and sensor data to generate actions for controlling a robot to perform at least part of a robotic assembly task.

The robot control techniques of the present disclosure have many real-world applications. For example, the robot control techniques could be used to control a physical robot in a real-world environment or a simulated robot in a virtual environment. As another example, the robot control techniques could be used to control other characters having movable joints like a robot.

The above examples are not in any way intended to be limiting. As persons skilled in the art will appreciate, as a general matter, the robot control techniques described herein can be implemented in any suitable application.

### System Overview

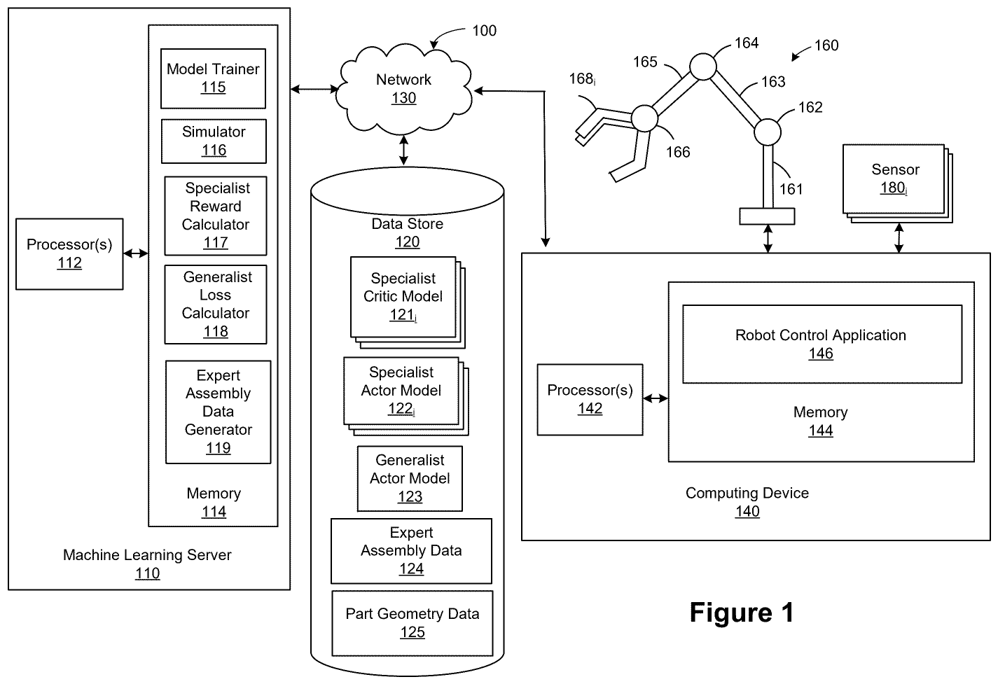

FIG. 1 illustrates a block diagram of a computer-based system 100 configured to implement one or more aspects of at least one embodiment. As shown, system 100 includes a machine learning server 110, a data store 120, and a computing device 140 in communication over a network 130, which can be a wide area network (WAN) such as the Internet, a local area network (LAN), a cellular network, and/or any other suitable network. Machine learning server 110 includes, without limitation, processor(s) 112 and a memory 114. Memory 114 includes, without limitation, a model trainer 115, a simulator 116, a specialist reward calculator 117, a generalist loss calculator 118, and an expert assembly data generator 119. Data store 120 includes, without limitation, specialist critic models 121i, specialist actor models 122i, a generalist actor model 123, an expert assembly data 124, and part geometry data 125. Computing device 140 includes, without limitation, processor(s) 142 and a memory 144. Memory 144 includes, without limitation, a robot control application 146.

Processor(s) 112 receive user input from input devices, such as a keyboard or a mouse. Processor(s) 112 may include one or more primary processors of machine learning server 110, controlling and coordinating operations of other system components. In particular, processor(s) 112 can issue commands that control the operation of one or more graphics processing units (GPUs) (not shown) and/or other parallel processing circuitry (e.g., parallel processing units, deep learning accelerators, etc.) that incorporates circuitry optimized for graphics and video processing, including, for example, video output circuitry. The GPU(s) can deliver pixels to a display device that can be any conventional cathode ray tube, liquid crystal display, light-emitting diode display, and/or the like.

System memory 114 of machine learning server 110 stores content, such as software applications and data, for use by processor(s) 112 and the GPU(s) and/or other processing units. System memory 114 can be any type of memory capable of storing data and software applications, such as a random-access memory (RAM), a read-only memory (ROM), an erasable programmable read-only memory (EPROM or Flash ROM), or any suitable combination of the foregoing. In some embodiments, a storage (not shown) can supplement or replace the system memory 114. The storage can include any number and type of external memories that are accessible to processor 112 and/or the GPU. For example, and without limitation, the storage can include a Secure Digital Card, an external Flash memory, a portable compact disc read-only memory (CD-ROM), an optical storage device, a magnetic storage device, and/or any suitable combination of the foregoing.

Machine learning server 110 shown herein is for illustrative purposes only, and variations and modifications are possible without departing from the scope of the present disclosure. For example, the number of processors 112, the number of GPUs and/or other processing unit types, the number of system memories 114, and/or the number of applications included in system memory 114 can be modified as desired. Further, the connection topology between the various units in FIG. 1 can be modified as desired. In some embodiments, any combination of processor(s) 112, system memory 114, and/or GPU(s) can be included in and/or replaced with any type of virtual computing system, distributed computing system, and/or cloud computing environment, such as a public, private, or a hybrid cloud system.

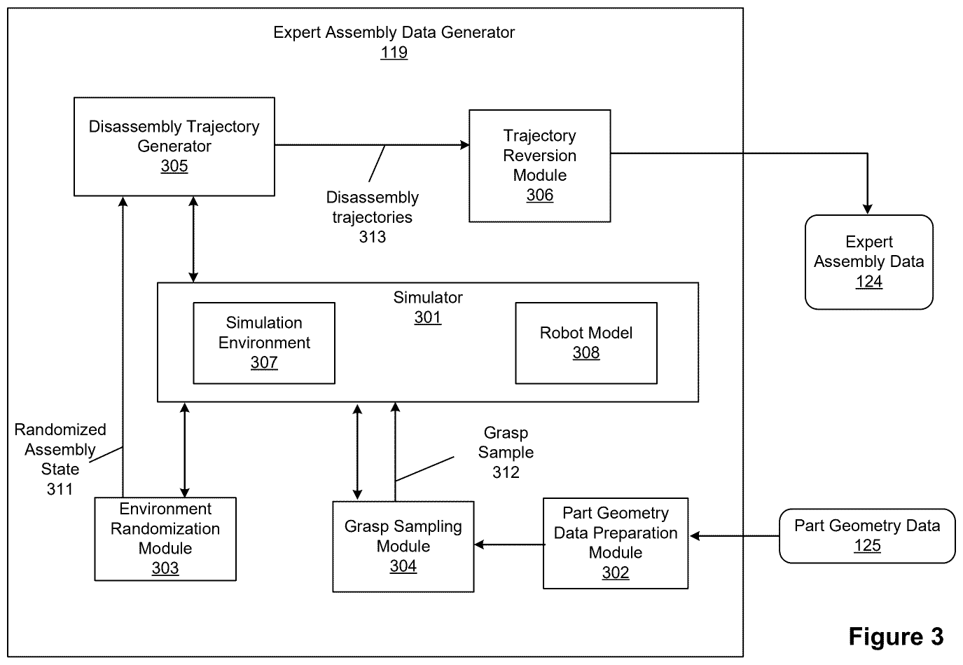

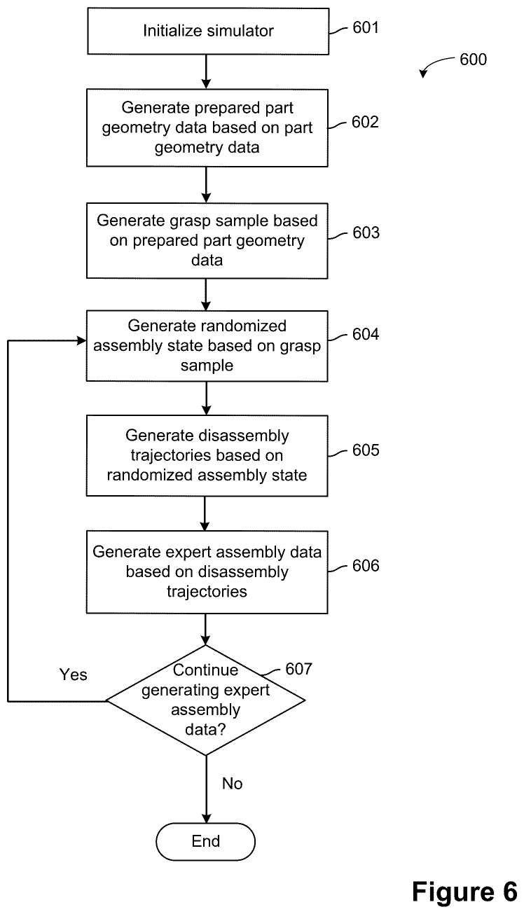

As shown, expert assembly data generator 119 executes on one or more processors 112 of machine learning server 110 and is stored in system memory 114 of machine learning server 110. In various embodiments, expert assembly data generator 119 is an application that uses part geometry data 125 stored in data store 120 to generate expert assembly data 124. Expert assembly data 124, which can be stored in data store 120 or elsewhere (e.g., in memory 114), includes reversed disassembly trajectories (e.g., time-ordered sequences of robot end-effector, positions, velocities, accelerations) and related information describing how a robot assembles a plurality of parts. Expert assembly data generator 119 is described in greater detail below in conjunction with FIGS. 3 and 6.

As shown, model trainer 115 is an application that executes on one or more processors 112 of machine learning server 110 and is stored in a system memory 114 of machine learning server 110. Although shown as distinct from the expert assembly data generator 119 for illustrative purposes, in some embodiments, functionality of the expert assembly data generator 119 and the model trainer 115 can be combined into a single application.

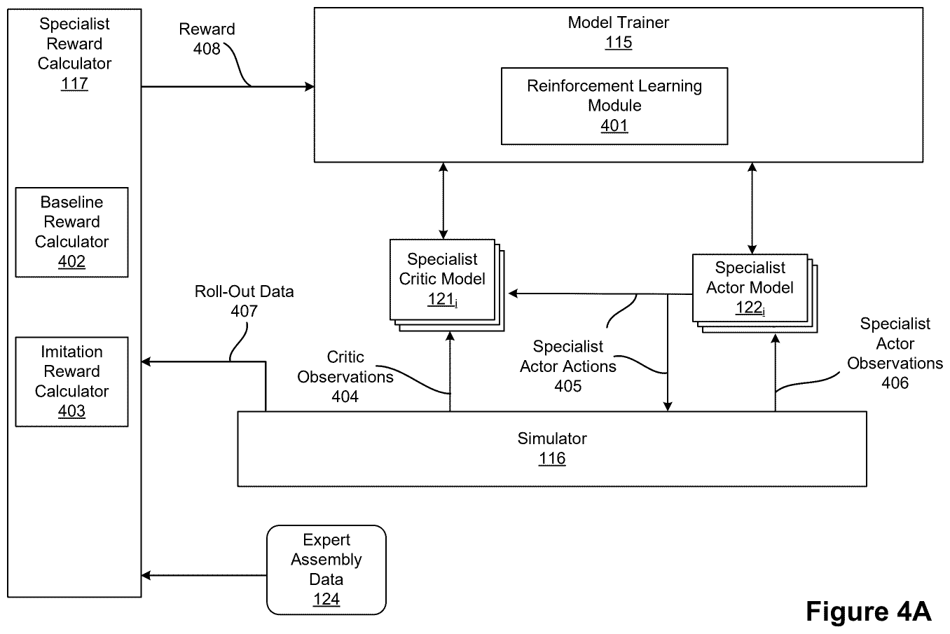

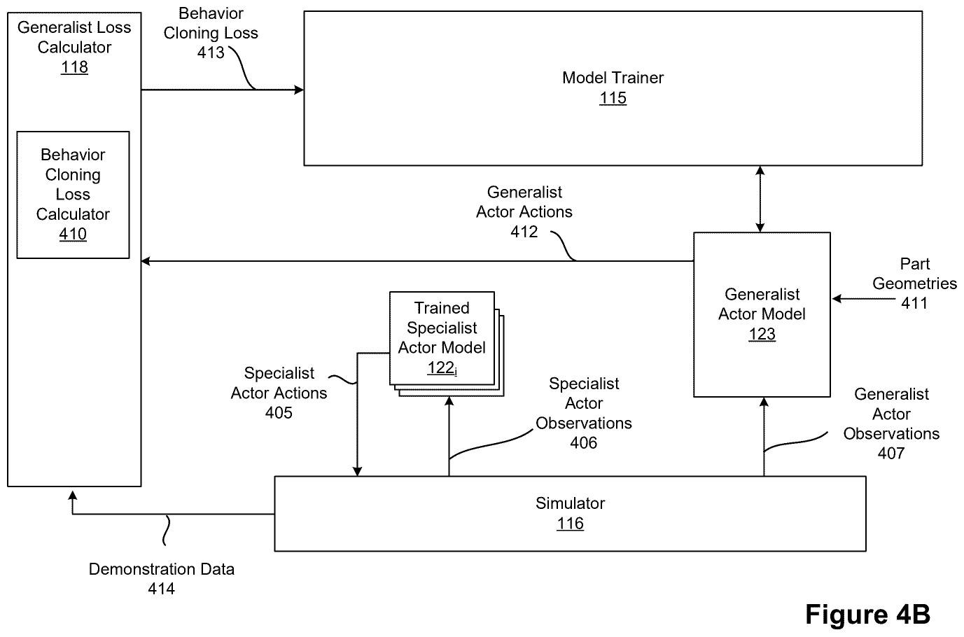

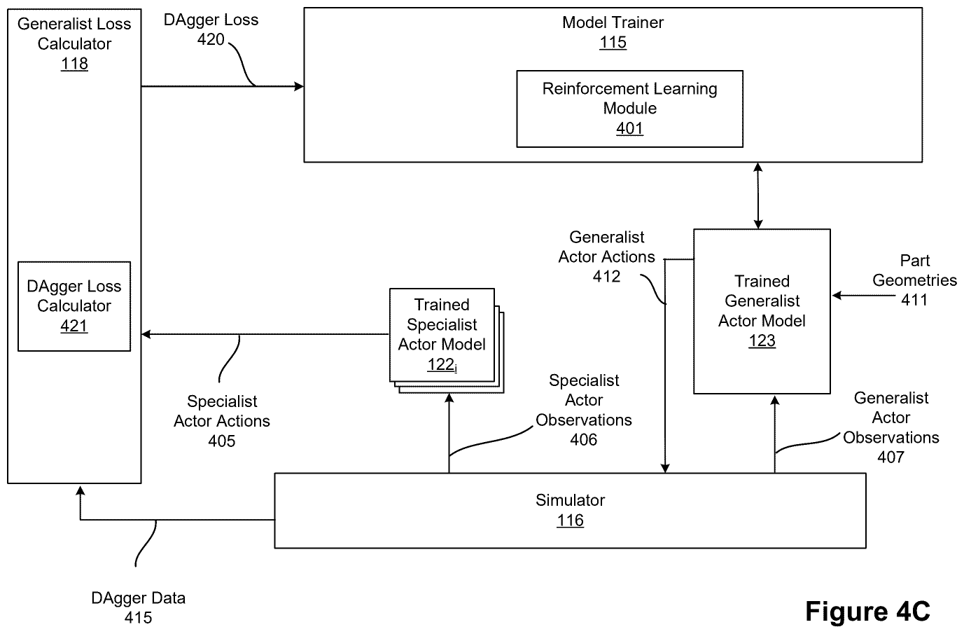

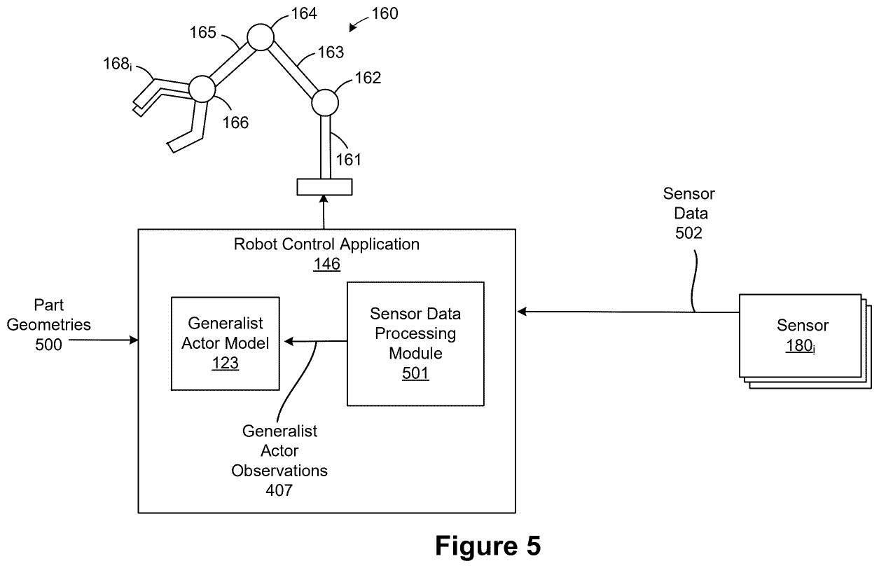

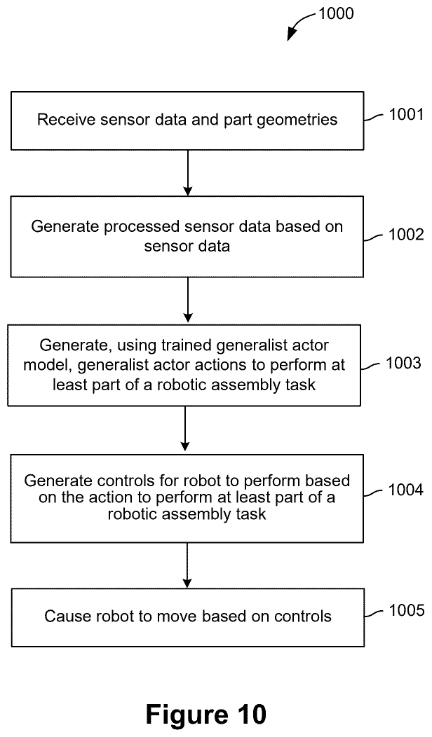

In some embodiments, model trainer 115 is configured to train one or more machine learning models, including specialist critic models 121i (referred to herein collectively as specialist critic models 121 and individually as a specialist critic model 121), specialist actor models 122i (referred to herein collectively as specialist actor models 122 and individually as a specialist actor model 122), and generalist actor model 123. Specialist actor models 122 and generalist actor model 123 are machine learning models, such as neural networks, which are trained to generate actions for a robot (e.g., robot 160) to perform at least part of a robotic assembly task based on one or more observations acquired via one or more sensors 180i (referred to herein collectively as sensors 180 and individually as a sensor 180), as discussed in greater detail below in conjunction with FIGS. 5 and 10. For example, in at least one embodiment, sensors 180 can include one or more cameras, one or more RGB-D cameras (e.g., cameras using time-of-flight sensors), such as a wrist-mounted RGB-D camera, one or more LIDAR sensors, any combination thereof, etc. Specialist critic models 121 are machine learning models, such as neural networks, which can be trained to evaluate actions generated by specialist actor models 122. Techniques for training specialist actor models 121, specialist critic models 122 and generalist actor model 123 based on expert assembly data 124 are discussed in greater detail herein in conjunction with at least FIGS. 4A-4C and 7-9. Specialist actor models 121, specialist critic models 122, and generalist actor model 123 can be stored in data store 120. Although shown as being stored in data store 120 in FIG. 1, specialist actor models 121, specialist critic models 122, and generalist actor model 123 can be stored in memory 114 during training or can be stored in memory 144 during inference. In some embodiments, the same computing device(s) can be used for training and inference after training, rather than the separate machine learning server 110 and computing device 140. In some embodiments, data store 120 can include any storage device or devices, such as fixed disc drive(s), flash drive(s), optical storage, network attached storage (NAS), and/or a storage area-network (SAN). Although shown as accessible over network 130, in at least one embodiment machine learning server 110 can include data store 120.

As shown, a robot control application 146 that uses generalist actor model 123 is stored in data store 120 accessed over network 130, and executes on processor(s) 142, of computer device 140. Once trained, trained generalist actor model 123 can be deployed, such as via robot control application 146, to control a physical robot in a real-world environment, such as robot 160. In various embodiments, trained generalist actor model 123 is deployed for use with virtual environments, such as in a simulator (not shown), where a virtual model of robot 160 is simulated within a virtual environment, such as a digital twin or a simulation platform. In the virtual deployment, robot control application 146 interfaces with a virtual representation of robot 160, which can enable testing, validation, and refinement of robot plans. Memory 144 and the processor(s) 142 can be similar to memory 114 and processor(s) 112 of machine learning server 110, described above. Robot control application 146 is discussed in greater detail below in conjunction with FIG. 5.

As shown, robot 160 includes multiple links 161, 163, and 165 that are rigid members, as well as joints 162, 164, and 166 that are movable components that can be actuated to cause relative motion between adjacent links. In addition, robot 160 includes multiple fingers 168i (referred to herein collectively as fingers 168 and individually as a finger 168) that can be controlled to grasp an object. For example, in at least one embodiment, robot 160 can include a locked wrist and multiple (e.g., four) fingers. Although an example robot 160 is shown for illustrative purposes, in at least one embodiment, techniques disclosed herein can be applied to control any suitable robot.

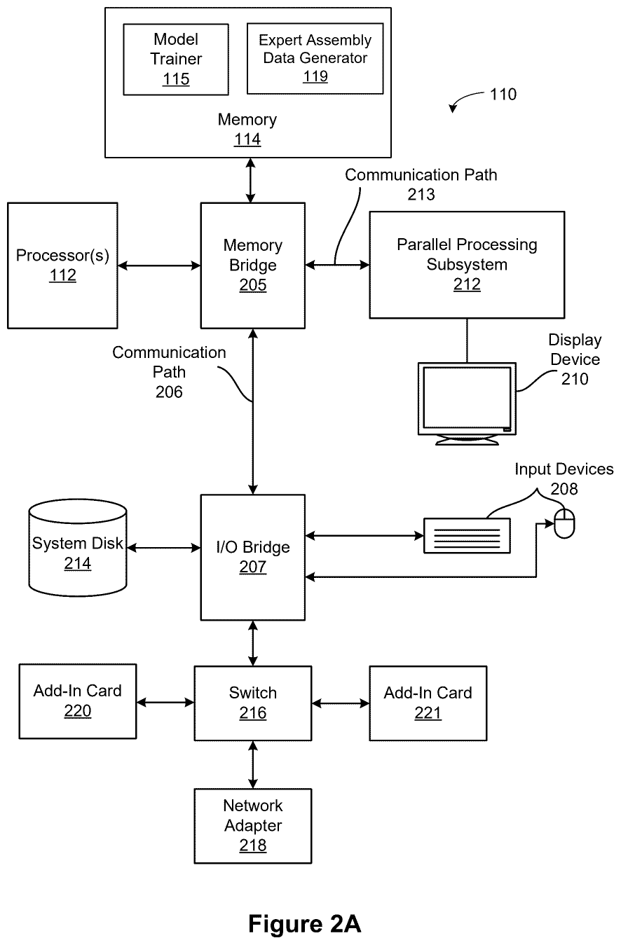

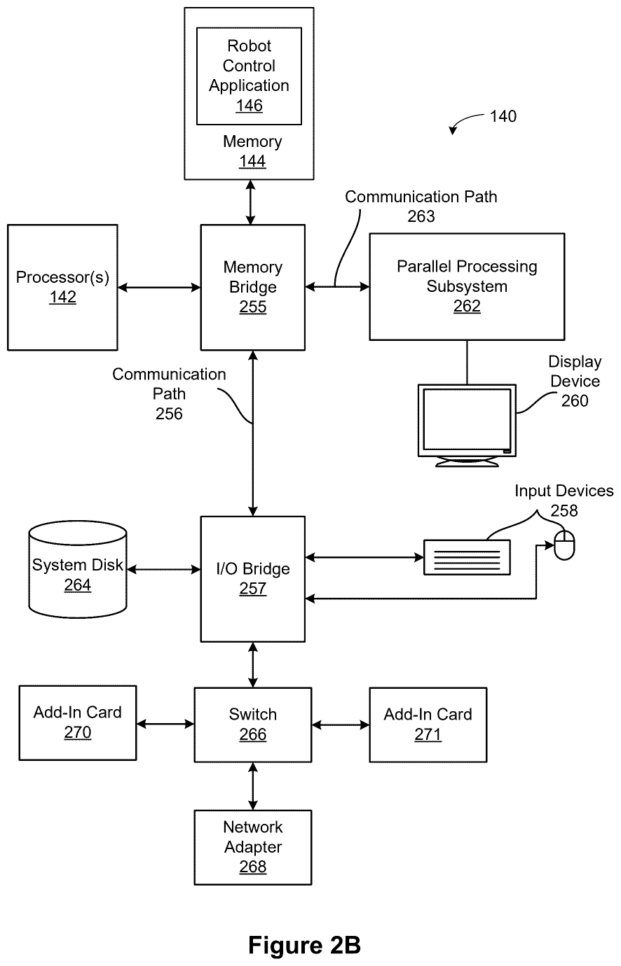

FIG. 2A is a block diagram illustrating machine learning server 110 of FIG. 1 in greater detail, according to various embodiments. Machine learning server 110 may include any type of computing system, including, without limitation, a server machine, a server platform, a desktop machine, a laptop machine, a hand-held/mobile device, a digital kiosk, an in-vehicle infotainment system, and/or a wearable device. In some embodiments, machine learning server 110 is a server machine operating in a data center or a cloud computing environment that provides scalable computing resources as a service over a network.

In various embodiments, machine learning server 110 includes, without limitation, processor(s) 112 and memory(ies) 114 coupled to a parallel processing subsystem 212 via a memory bridge 205 and a communication path 213. Memory bridge 205 is further coupled to an I/O (input/output) bridge 207 via a communication path 206, and I/O bridge 207 is, in turn, coupled to a switch 216.

In one embodiment, I/O bridge 207 is configured to receive user input information from optional input devices 208, such as a keyboard, mouse, touch screen, sensor data analysis (e.g., evaluating gestures, speech, or other information about one or more uses in a field of view or sensory field of one or more sensors), and/or the like, and forward the input information to processor(s) 112 for processing. In some embodiments, machine learning server 110 may be a server machine in a cloud computing environment. In such embodiments, machine learning server 110 may not include input devices 208, but may receive equivalent input information by receiving commands (e.g., responsive to one or more inputs from a remote computing device) in the form of messages transmitted over a network and received via network adapter 218. In some embodiments, switch 216 is configured to provide connections between I/O bridge 207 and other components of machine learning server 110, such as a network adapter 218 and various add-in cards 220 and 221.

In some embodiments, I/O bridge 207 is coupled to a system disk 214 that may be configured to store content and applications and data for use by processor(s) 142 and parallel processing subsystem 212. In one embodiment, system disk 214 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high-definition DVD), or other magnetic, optical, or solid state storage devices. In various embodiments, other components, such as universal serial bus or other port connections, compact disc drives, digital versatile disc drives, film recording devices, and the like, may be connected to I/O bridge 207 as well.

In various embodiments, memory bridge 205 may be a Northbridge chip, and I/O bridge 207 may be a Southbridge chip. In addition, communication paths 206 and 213, as well as other communication paths within machine learning server 110, may be implemented using any technically suitable protocols, including, without limitation, AGP (Accelerated Graphics Port), HyperTransport, or any other bus or point-to-point communication protocol known in the art.

In some embodiments, parallel processing subsystem 212 comprises a graphics subsystem that delivers pixels to an optional display device 210 that may be any conventional cathode ray tube, liquid crystal display, light-emitting diode display, and/or the like. In such embodiments, parallel processing subsystem 212 may incorporate circuitry optimized for graphics and video processing, including, for example, video output circuitry. Such circuitry may be incorporated across one or more parallel processing units (PPUs), also referred to herein as parallel processors, included within parallel processing subsystem 212.

In some embodiments, parallel processing subsystem 212 incorporates circuitry optimized (e.g., that undergoes optimization) for general purpose and/or compute processing. Again, such circuitry may be incorporated across one or more PPUs included within parallel processing subsystem 212 that are configured to perform such general purpose and/or compute operations. In yet other embodiments, the one or more PPUs included within parallel processing subsystem 212 may be configured to perform graphics processing, general purpose processing, and/or compute processing operations. System memory 114 includes at least one device driver configured to manage the processing operations of the one or more PPUs within parallel processing subsystem 212. In addition, system memory 114 includes, without limitation, model trainer 115 and expert assembly data generator 119. Although described herein primarily with respect to model trainer 115 and expert assembly data generator 119, techniques disclosed herein can also be implemented, either entirely or in part, in other software and/or hardware, such as in parallel processing subsystem 212.

In various embodiments, parallel processing subsystem 212 may be integrated with one or more of the other elements of FIG. 2A to form a single system. For example, parallel processing subsystem 212 may be integrated with processor 142 and other connection circuitry on a single chip to form a system on a chip (SoC).

In some embodiments, processor(s) 112 includes the primary processor of machine learning server 110, controlling and coordinating operations of other system components. In some embodiments, processor(s) 112 issues commands that control the operation of PPUs. In some embodiments, communication path 213 is a PCI Express link, in which dedicated lanes are allocated to each PPU. Other communication paths may also be used. The PPU advantageously implements a highly parallel processing architecture, and the PPU may be provided with any amount of local parallel processing memory (PP memory).

It will be appreciated that the system shown herein is illustrative and that variations and modifications are possible. The connection topology, including the number and arrangement of bridges, the number of CPUs 112, and the number of parallel processing subsystems 212, may be modified as desired. For example, in some embodiments, system memory 114 could be connected to the processor(s) 112 directly rather than through memory bridge 205, and other devices may communicate with system memory 114 via memory bridge 205 and processor 112. In other embodiments, parallel processing subsystem 212 may be connected to I/O bridge 207 or directly to processor 112, rather than to memory bridge 205. In still other embodiments, I/O bridge 207 and memory bridge 205 may be integrated into a single chip instead of existing as one or more discrete devices. In certain embodiments, one or more components shown in FIG. 2A may not be present. For example, switch 216 could be eliminated, and network adapter 218 and add-in cards 220, 221 would connect directly to I/O bridge 207. Lastly, in certain embodiments, one or more components shown in FIG. 2A may be implemented as virtualized resources in a virtual computing environment, such as a cloud computing environment. In particular, the parallel processing subsystem 212 may be implemented as a virtualized parallel processing subsystem in at least one embodiment. For example, the parallel processing subsystem 212 may be implemented as a virtual graphics processing unit(s) (vGPU(s)) that renders graphics on a virtual machine(s) (VM(s)) executing on a server machine(s) whose GPU(s) and other physical resources are shared across one or more VMs.

FIG. 2B is a block diagram illustrating computing device 140 of FIG. 1 in greater detail, according to various embodiments. Computing device 140 may include any type of computing system, including, without limitation, a server machine, a server platform, a desktop machine, a laptop machine, a hand-held/mobile device, a digital kiosk, an in-vehicle infotainment system, and/or a wearable device. In some embodiments, computing device 140 is a server machine operating in a data center or a cloud computing environment that provides scalable computing resources as a service over a network. In some embodiments, machine learning server 110 can include one or more similar components as computing device 140.

In various embodiments, computing device 140 includes, without limitation, processor(s) 142 and memory(ies) 144 coupled to a parallel processing subsystem 262 via a memory bridge 255 and a communication path 263. Memory bridge 255 is further coupled to an I/O (input/output) bridge 257 via a communication path 256, and I/O bridge 257 is, in turn, coupled to a switch 266.

In one embodiment, I/O bridge 257 is configured to receive user input information from optional input devices 258, such as a keyboard, mouse, touch screen, sensor data analysis (e.g., evaluating gestures, speech, or other information about one or more uses in a field of view or sensory field of one or more sensors), and/or the like, and forward the input information to processor(s) 142 for processing. In some embodiments, computing device 140 may be a server machine in a cloud computing environment. In such embodiments, computing device 140 may not include input devices 258, but may receive equivalent input information by receiving commands (e.g., responsive to one or more inputs from a remote computing device) in the form of messages transmitted over a network and received via network adapter 268. In some embodiments, switch 266 is configured to provide connections between I/O bridge 257 and other components of computing device 140, such as a network adapter 268 and various add-in cards 270 and 271.

In some embodiments, I/O bridge 257 is coupled to a system disk 264 that may be configured to store content and applications and data for use by processor(s) 142 and parallel processing subsystem 262. In one embodiment, system disk 264 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high-definition DVD), or other magnetic, optical, or solid state storage devices. In various embodiments, other components, such as universal serial bus or other port connections, compact disc drives, digital versatile disc drives, film recording devices, and the like, may be connected to I/O bridge 257 as well.

In various embodiments, memory bridge 255 may be a Northbridge chip, and I/O bridge 257 may be a Southbridge chip. In addition, communication paths 256 and 263, as well as other communication paths within computing device 140, may be implemented using any technically suitable protocols, including, without limitation, AGP (Accelerated Graphics Port), HyperTransport, or any other bus or point-to-point communication protocol known in the art.

In some embodiments, parallel processing subsystem 262 comprises a graphics subsystem that delivers pixels to an optional display device 260 that may be any conventional cathode ray tube, liquid crystal display, light-emitting diode display, and/or the like. In such embodiments, parallel processing subsystem 262 may incorporate circuitry optimized for graphics and video processing, including, for example, video output circuitry. Such circuitry may be incorporated across one or more parallel processing units (PPUs), also referred to herein as parallel processors, included within parallel processing subsystem 262.

In some embodiments, parallel processing subsystem 262 incorporates circuitry optimized (e.g., that undergoes optimization) for general purpose and/or compute processing. Again, such circuitry may be incorporated across one or more PPUs included within parallel processing subsystem 262 that are configured to perform such general purpose and/or compute operations. In yet other embodiments, the one or more PPUs included within parallel processing subsystem 262 may be configured to perform graphics processing, general purpose processing, and/or compute processing operations. System memory 144 includes at least one device driver configured to manage the processing operations of the one or more PPUs within parallel processing subsystem 262. In addition, system memory 144 includes robot control application 146. Although described herein primarily with respect to robot control application 146, techniques disclosed herein can also be implemented, either entirely or in part, in other software and/or hardware, such as in parallel processing subsystem 262.

In various embodiments, parallel processing subsystem 262 may be integrated with one or more of the other elements of FIG. 2B to form a single system. For example, parallel processing subsystem 262 may be integrated with processor 142 and other connection circuitry on a single chip to form a system on a chip (SoC).

In some embodiments, processor(s) 142 includes the primary processor of computing device 140, controlling and coordinating operations of other system components. In some embodiments, processor(s) 142 issue commands that control the operation of PPUs. In some embodiments, communication path 263 is a PCI Express link, in which dedicated lanes are allocated to each PPU. Other communication paths may also be used. The PPU advantageously implements a highly parallel processing architecture, and the PPU may be provided with any amount of local parallel processing memory (PP memory).

It will be appreciated that the system shown herein is illustrative and that variations and modifications are possible. The connection topology, including the number and arrangement of bridges, the number of CPUs 142, and the number of parallel processing subsystems 262, may be modified as desired. For example, in some embodiments, system memory 144 could be connected to processor(s) 142 directly rather than through memory bridge 255, and other devices may communicate with system memory 144 via memory bridge 255 and processor 142. In other embodiments, parallel processing subsystem 262 may be connected to I/O bridge 257 or directly to processor 142, rather than to memory bridge 255. In still other embodiments, I/O bridge 257 and memory bridge 255 may be integrated into a single chip instead of existing as one or more discrete devices. In certain embodiments, one or more components shown in FIG. 2B may not be present. For example, switch 266 could be eliminated, and network adapter 268 and add-in cards 270, 271 would connect directly to I/O bridge 257. Lastly, in certain embodiments, one or more components shown in FIG. 2B may be implemented as virtualized resources in a virtual computing environment, such as a cloud computing environment. In particular, parallel processing subsystem 262 may be implemented as a virtualized parallel processing subsystem in at least one embodiment. For example, parallel processing subsystem 262 may be implemented as a virtual graphics processing unit(s) (vGPU(s)) that renders graphics on a virtual machine(s) (VM(s)) executing on a server machine(s) whose GPU(s) and other physical resources are shared across one or more VMs.

### Expert Assembly Data Generation Using Part Geometry Data

FIG. 3 is a more detailed illustration of expert assembly data generator 119 of FIG. 1, according to various embodiments. Expert assembly data generator 119 processes part geometry data 125 and generates expert assembly data 124. As shown, expert assembly data generator 119 includes, without limitation, a part geometry data preparation module 302, an environment randomization module 303, a simulator 301, a grasp sampling module 304, a disassembly trajectory generator 305, and a trajectory reversion module 306. Simulator 301 includes, without limitation, a robot model 308 and a simulation environment 307. In operation, part geometry data preparation module 302 processes part geometry data 125 and generates prepared part geometry data (not shown). Grasp sampling module 304 interacts with simulator 301 and generates grasp sample 312 based on prepared part geometry data. Environment randomization module 303 processes the grasp sample 312 and generates a randomized assembly state 311. Simulator 301 uses robot model 308 and simulation environment 301 to simulate the randomized assembly state 311. Disassembly trajectory generator interacts with simulator 301 and uses randomized assembly state 311, robot model 308, and prepared part geometry data for parts that robot model 308 is simulated disassembling while grasping one of the parts using grasp sample 312, to generate one or more disassembly trajectories 313. Trajectory reversion module 306 processes disassembly trajectories 313 and generates expert assembly data 124.

Part geometry data preparation module 302 processes part geometry data 125 and generates prepared part geometry data. Part geometry data 125 includes, without limitation, one or more three-dimensional representations of plug, socket, or other assembly parts, which may be stored in polygon mesh files, CAD-based parametric models, or similar digital formats. In some embodiments, part geometry data 125 also includes metadata describing part dimensions, allowable tolerances, surface normal, and/or the like. In various embodiments, part geometry preparation module 302 applies one or more mesh manipulations to permit feasibility in simulation or real-world assembly. The manipulations include scaling unitless meshes so the bounding box aligns with typical robot work envelopes, reorienting each part so the primary assembly axis corresponds to a global axis, and translating the mesh so the bottom surface is coplanar with the global origin, and/or the like. In scaling unitless meshes, part geometry data preparation module 302, can, for example, units of meters, draws an oriented bounding box, and scales the part mesh such that the longest edge of the bounding box is at a fixed length (e.g., 10 cm), allowing the part to be grasped by robotic manipulators. In reorientation, geometry data preparation module 302 reorients the mesh such that the primary axis of assembly (e.g., the insertion direction) is aligned with the global z-axis. In translation, part geometry data preparation module 302 translates the part mesh such that the bottom surface of the part mesh is coplanar with the global origin when the part mesh is in an assembled state. In some embodiments, part geometry data preparation module 302 prepares part meshes for depenetration and clearance by shifting vertices to achieve a desired radial gap between two parts, such as a plug and socket. Although described herein primarily with respect to a plug and a socket as a reference example, in some embodiments, techniques disclosed herein can be applied to train specialist and generalist actor models to control robots to assemble any suitable types of parts. In some examples, when the part mesh is a plug, part geometry data preparation module 302 temporarily instantiates the corresponding socket. For each vertex on the plug, part geometry data preparation module 302 computes a signed distance to the socket along the vertex normal. If the distance is negative corresponding to interpenetration or less than a desired radial clearance (e.g., 0.5 mm), part geometry data preparation module 302 translates the vertex backward along the normal until achieving the desired clearance. In some embodiments, when the latter procedure produces unexpected results, such as when the plug is very thin or the socket is hollow, part geometry data preparation module 302 can prompt a user to perform manual corrections via a user interface. In some embodiments, part geometry data preparation module 302 optionally chamfers contact edges to reduce burrs and ease insertion. In some examples, part geometry data preparation module 302 chamfers the contacting edges of a plug and socket. Chamfers are common in assemblies, as chamfers facilitate manual assembly, reduce stress concentrations, and remove burrs. For a cylindrical peg, chamfer sizes of 1/10 to ¼ of the diameter can be used. For example, when plugs included in part geometry data 125 have a diameter of ˜10 mm, part geometry data preparation module 302 could apply chamfers with a length of 1 mm and angle of 45 degrees. Both chamfered and unchamfered versions of part meshes are included in the prepared part geometry data. In some embodiments, part geometry data preparation module 302 subdivides the part meshes included in part geometry data 125 to generate sufficient vertices for stable collision modeling. In some examples, part geometry data preparation module 302 subdivides the part meshes until generating a minimum number of vertices (e.g., 2000 vertices). In some examples, part geometry data preparation module 302 samples 100 assemblies from part geometry data 125 that consist of 2 parts, are geometrically diverse, have graspable surfaces, require insertion rather than simply alignment, and can be assembled approximately top-down, where most assemblies have at least 1 axisymmetric part that has a symmetry-breaking feature. The resultant prepared part geometry data includes assemblies that are all interpenetration-free and have a fixed (e.g., 1 mm) diametral clearance. Furthermore, the prepared part geometry data can include assemblies that have high triangle density, allowing simulation with fast contact methods that collide meshes against signed distance fields. In addition, in some embodiments, the parts included in prepared part geometry data can be 3D printed and assembled in the real world.

Grasp sampling module 304 interacts with simulator 301 and generates a grasp sample 312. In various embodiments, the robot in simulator 301 has to first grasp the second part, such as the plug, before assembling or disassembling the second part and another part (e.g., a socket), and the success of the assembly or disassembly process depends on the quality of the grasp. For each assembly, grasp sampling module 304 performs a grasp optimization procedure to determine a grasp that leads to a high probability of success during assembly or disassembly. The grasp optimization procedure includes two steps of grasp sampling and physics-based evaluation. In the grasp sampling step, grasp sampling module 304 uses a kinematics and geometry-based grasp sampling approach. For each assembly, grasp sampling module 304 first initializes the meshes (i.e., the geometries) of the second part and the first part in the assembled state. Grasp sampling module 304 instantiates a robot gripper mesh (i.e., geometry associated with the robot gripper), randomly samples a surface normal on the mesh of the second part, and aligns the central axis of the gripper to be collinear with the surface normal. Grasp sampling module 304 then randomly samples a position along the normal and translates the gripper to the position along the normal. Grasp sampling module 304 then generates the grasp sample 312 as the 6-DOF pose of the gripper. In some embodiments, grasp sampling module 304 selects a grasp sample 312 (e.g., grasp pose) from various candidate grasp samples (e.g., candidate grasp poses) and rejects a grasp sample candidate if 1) the robot hand intersects the meshes of the first part or the second part, 2) the mesh of the second part does not intersect the gripper closing region (e.g., the prismatic volume contained between the fully-opened gripper fingers), or 3) the Euler angles of the gripper are outside of specified bounds (e.g., [−15, 15] degrees for roll and pitch and [−120, 120] degrees for yaw) to ensure that the robot remains in a region of the workspace with high manipulability. In some embodiments, grasp sampling module 304 repeats the steps of grasp sampling until generating a fixed number of (e.g., 100) grasp samples 312. In the physics-based evaluation step, grasp sampling module 304 performs physics-based evaluations to guarantee the grasp samples 312 to be stable during the contact-rich interactions experienced during assembly and disassembly. For each assembly, grasp sampling module 304 first randomizes the pose of the first part, such as a socket, over a wide range, and grasp sampling module 304 initializes the second part, such as a plug, in the assembled state (e.g., inserted in the first part). For each of the grasp samples 312 in the grasp sampling step, grasp sampling module 304 executes the grasp on the second part using simulator 301. Grasp sampling module 304 then uses a task-space impedance controller to lift the second part from the socket until the convex hull of the second part no longer intersects the convex hull of the first part, and grasp sampling module 304 moves the robot gripper to a pose in free space randomly sampled from specified bounds (e.g., [−0.05, 0.05] for X- and Y-position, [0, 0.05] for Z-position, and [−10, 10] deg for roll, pitch, and yaw). In some embodiments, grasp sampling module 304 checks whether the grasp is successful (e.g., if the plug remains in the gripper fingers until the end of the assembly procedure). In various embodiments, grasp sampling module 304 repeats the physics-based evaluation step for a fixed number of times (e.g., 1000 times). Finally, grasp sampling module 304 identifies the grasp sample 312 with the highest success rate and designates that grasp sample 312 as the highest-performing grasp for the given assembly task. In some examples, grasp sampling module 304 uses simulator 301 to run 10 million trials including 100 assembly task×100 grasps per assembly task×1000 trials per grasp sample, which can be distributed over a plurality of parallel simulation environments included in simulation environment 307 for efficiency. In various embodiments, grasp sampling module 304 generates grasp sample 312 as a dictionary that maps each assembly task to the highest-performing grasp for the corresponding second part. Grasp sample 312 can be inherently collision-free with respect to the first part in the assembled state, robust to large variations in robot configuration and poses of the first and the second parts, and robust to contact-rich interactions.

Environment randomization module 303 interacts with simulator 301 and processes the grasp sample 312 to generate a randomized assembly state 311. In various embodiments, environment randomization module 303 randomizes the part geometry of at least one part in the simulator. In some embodiments, environment randomization module 303 first randomizes the position of the first part, such as a socket, and orientation within specified ranges (e.g., x∈[0.40, 0.60] m, y∈[−0.10, 0.10] m, z∈[0.16, 0.18] m, and roll/pitch/yaw∈[−5, 5] deg). Next, the pose of the second part, such as a plug, is randomized relative to the first part from fixed intervals (e.g., x∈[−10, 10] mm, y∈[−10, 10] mm, z∈[10, 20] mm, and roll/pitch/yaw∈[−5, 5] deg). Environment randomization module 303 then moves the robot gripper near the pose of the second part and optionally applies a second stage of randomization for x, y, z, roll, pitch, and yaw relative to the gripper from a fixed interval (e.g., ∈[−5, 5] deg for orientations). Environment randomization module 303 samples the values for first part position and orientation, second part pose, and second part pose relative to the gripper of the robot from uniform distributions to generate diverse initial conditions. Environment randomization module 303 also generates a goal state included in randomized assembly state 311 by inserting each second part into the corresponding first part. In various embodiments, environment randomization module 303 modifies initial states included in randomized assembly state 311 for custom applications.

Simulator 301 processes randomized assembly state 311 and simulates the disassembly task. As shown, simulator 301 includes robot model 308 and simulation environment 307. Robot model 308 defines the forward-kinematics relationship of robot, which can be described as

$${X}_{E E} = f ( Θ ) , \qquad ( Equation 1 )$$

where θ∈ [symbol] is the robot's joint-angle configuration and X_{EE}∈SE(3) is the end-effector pose. SE(3) is the “special Euclidean group” in three dimensions and denotes the space of all possible rigid transformations in three-dimensional space. Each element of SE(3) specifies a rotation (often represented by a 3×3 orthonormal matrix or a quaternion) and a translation (a 3D displacement), thereby describing the full position and orientation of an object. In some embodiments, simulator 301 applies a control law

$$T = {g}_{ψ} ( Θ , {X}_{E E} , U ( t ) ) , \qquad ( Equation 2 )$$

where T∈ [symbol] is the vector of joint torques, ψ denotes constant parameters (e.g., control gains), and U(t)∈ [symbol] ∪SE(3) is a control target in either joint space ( [symbol] ) or task space (SE(3)). In various embodiments, the initial grasp poses of an end errector

$${X}_{E E}^{0}$$

plug

$${X}_{P}^{0}$$

and socket

$${X}_{S}^{0}$$

are drawn from uniform distributions over user-defined bounds. For example,

$${X}_{E E}^{0}$$

˜Uniform

$${a}_{EE}^{0} , {b}_{E E}^{0}$$

$${X}_{P}^{0}$$

˜Uniform

$$( {a}_{P}^{0} , {b}_{P}^{0} ) , {X}_{S}^{0}$$

### ∫Uniform

$${a}_{S}^{0} , {b}_{S}^{0}$$

where

$${a}_{E E}^{0} , {b}_{E E}^{0} , {a}_{P}^{0} , {b}_{P}^{0} , {a}_{S}^{0} , and {b}_{S}^{0}$$

are user-specified bounds in position/orientation space. The initial poses permit that the convex hulls of the plug and socket meshes, M_{P} and M_{S}, do not overlap in ways that prevent valid assembly. A goal pose

$${X}_{P}^{G}$$

can also be defined so that the surfaces of the first part and the second part align upon contact without interpenetration.

Simulation environment 307 is a physics-based software module or library configured to approximate real-world dynamics for parts, such as a plug and a socket, and the robot in three-dimensional space. Simulation environment 307 enforces rigid-body dynamics, collision detection, contact resolution, friction, and gravity models, and may also accommodate soft constraints, such as compliant joints, force/torque sensing, and/or the like in the robot end effector. In some embodiments, simulation environment 307 includes ready-to-use, parallelized simulation environments for various robotic assembly tasks in a given dataset (e.g., one hundred distinct plug-socket pairs). In various embodiments, simulator 301 updates states (e.g., positions, velocities, and accelerations) at discrete time steps. In some embodiments, during simulation, simulator 301 uses signed-distance-field (SDF)-based collisions such that a single contact per triangle is generated.

Disassembly trajectory generator 305 interacts with simulator 301 and processes randomized assembly state 311 to generate disassembly trajectories 313. In various embodiments, disassembly trajectory generator 305 simulates grasp sample 312 and randomized assembly state 311 in simulator 301 to generate disassembly trajectories 313. Each disassembly trajectory 313 Dᵢ includes states

$$x = [ {x}_{i}^{1} , {x}_{i}^{2} , … , {x}_{i}^{{N}_{i}} ] ,$$

where N is the number of states, each state

$${x}_{i}^{j}$$

can be defined as

$$[ {p}_{i}^{j} ; {v}_{i}^{j} ; {a}_{i}^{j} ] ,$$

where p is position, v is velocity, and a is acceleration. As described, in some embodiments, generating the disassembly trajectories can include using a task-space impedance controller to lift the grasped part from a socket until the convex hull of the grasped part no longer intersects the convex hull of the socket, then moving the robot gripper to a pose in free space that is randomly sampled from specified bounds. In some other embodiments, the disassembly can be performed along any suitable direction (as opposed to the up-down direction), such as along a direction specified by a directional vector. Although described herein primarily with respect to disassembling a plug from a socket as a reference example, any suitable disassembly can be performed in some embodiments, such as a disassembly that involves iteratively moving the grasped part in the x, y, z, and rotational directions to find a direction that works for the disassembly, and trying another direction if a direction does not work.

Trajectory reversion module 306 processes disassembly trajectories 313 to generate expert assembly data 124, which provides demonstration data for training specialist actor models to perform different assembly tasks. In various embodiments, trajectory reversion module 306 generates expert assembly data 124 by reversing disassembly trajectories 313 Dᵢ′ described as

$${x}_{i}^{′} = [ {x}_{i}^{{N}_{i}} , {x}_{i}^{{N}_{i} - 1} , … , {x}_{i}^{1} ] ,$$

which can naively be used as an assembly demonstration. In various embodiments, since the corresponding velocities

$${v}_{i}^{′} = [ {v}_{i}^{{N}_{i}} , {v}_{i}^{{N}_{i} - 1} , … , {v}_{i}^{1} ]$$

and accelerations

$${a}_{i}^{′} = [ {a}_{i}^{{N}_{i}} , {a}_{i}^{{N}_{i} - 1} , … , {a}_{i}^{1} ]$$

are in general nonphysical, the velocities and accelerations are not included in expert assembly data 124. Then, for each successful trial, trajectory reversion module 306 includes only the reversed disassembly positions (e.g., paths)

$${p}_{i}^{′} = [ {p}_{i}^{{N}_{i}} , {p}_{i}^{{N}_{i} - 1} , … , {p}_{i}^{1} ]$$

in the expert assembly data 124.

### Training Specialist Actor Models and Generalist Actor Model Using Expert Assembly Data

FIG. 4A illustrates how model trainer 115 trains specialist actor models, according to various embodiments. As shown, model trainer 115 includes a reinforcement learning module 401, and specialist reward calculator 117 includes a baseline reward calculator 402 and an imitation reward calculator 403. In operation, simulator 116 generates one or more specialist actor observations 406. Specialist actor models 122 process specialist actor observations 406 and generate specialist actor actions 405, which are applied to simulator 116 to generate new specialist actor observations 406 and critic observations 404. Specialist critic models 121 evaluate specialist actor actions 405 using the critic observations 404 and generate critic evaluations. Simulator 116 then generates roll-out data 407, which is simulated data that includes robot and parts states as well as specialist actor observations 406. Specialist reward calculator 117 calculates reward 408 based on the roll-out data 407 and expert assembly data 124. Reinforcement learning module 401 then updates one or more parameters of specialist actor models 122 and specialist critic models 121 based on reward 408 and critic evaluations iteratively, until a stopping criterion is met.

Specialist actor models 122 process specialist actor observations 406 and generate specialist actor actions 405. In various embodiments, specialist actor observations 406 include at least one of the following observations: (1) the robot arm joint angles specified by a 7-dimensional vector, (2) the fingertip (e.g., end-effector) pose, typically specified by a 3D position plus a 4-element quaternion, (3) target pose with noise specified by a 3D position plus a 4-element quaternion, or (4) the relative transformation of the target pose with noise specified by a 3D position plus a 4-element quaternion. In some embodiments, specialist actor models 122 include various neural network layers, including but not limited to layers of multi-layer perceptron (MLP) networks and long-short-term-memory (LSTM) networks. Specialist actor actions 405 includes incremental pose targets (e.g., end-effector poses) in SE(3), which represent the position and orientation difference between the current pose xₓ and the target pose xₜ. In various embodiments, the incremental targets rather than absolute targets are chosen to select from a small, bounded spatial range.

Specialist critic models 121 process critic observations 404 and generate critic evaluations. In various embodiments, critic observations 404 include privileged information that is not provided to the specialist actor models 122, as the specialist critic models 121 are only used for training and are not deployed in the real world. In various embodiments, critic observations 404 include but are not limited to (1) the robot arm joint angles specified by a 7-dimensional vector, (2) the fingertip (e.g., end-effector) pose, typically specified by a 3D position plus a 4-element quaternion, (3) target pose specified by a 3D position plus a 4-element quaternion, (4) arm joint velocities specified by a 7-dimensional vector, (5) fingertip (e.g., end-effector) linear velocity specified by a 3-dimensional vector, (6) fingertip angular velocity specified by a 3-dimensional vector, (7) plug pose specified by a 3D position plus a 4-element quaternion, and (8) relative target pose specified by a 3D position plus a 4-element quaternion. In various embodiments, each specialist critic model 121 is a parametric function V_{ϕ}:0× [symbol] → [symbol] with parameters ϕ. Given a critic observation 404 o∈0 and a specialist actor action 405 a∈ [symbol] , V_{ϕ} outputs a scalar value representing the estimated expected return from that state-action pair. In some examples, \hat{Q}(o, a)=V_{ϕ} (o, a), where \hat{Q}(o, a) approximates the cumulative discounted reward that would follow when the robot continued from o with action a and thereafter acted according to the policy. The parametric function V_{ϕ} can be realized as a neural network or another regression model, taking as input the numerical encodings of o (e.g., joint angles, plug pose) and a (e.g., desired joint torques or end-effector commands), and generating a single real-valued output (e.g., critic evaluation). In some embodiments, specialist critic models 121 includes but is not limited to MLP networks.

Simulator 116 processes specialist actor actions 405 and generates specialist actor observations, critic observations 404, and roll-out data 407. In various embodiments, simulator 116 is similar to simulator 301 and includes a robot model and a simulation environment. In various embodiments, simulator 116 can be instantiated in parallel across multiple worker processes, allowing the collection of roll-out data 407 corresponding to multiple specialist actor models 122 simultaneously. In some embodiments, since each specialist actor model 122 explores different initial poses or part configurations, simulator 116 tracks collisions, contact forces, and successful insertions, building a dataset of transition tuples (s, a, s′) included in roll-out data 407, where s is the current state (e.g., robot joint angles and plug pose), a is the specialist actor action 405, and s′ is the next state after applying a.

Specialist reward calculator 117 processes expert assembly data 124 and roll-out data 407 and generates reward 408. As shown, specialist reward calculator 117 includes baseline reward calculator 402 and imitation reward calculator 403. Baseline reward calculator 402 calculates reward terms that penalize distance-to-goal, penalize simulation error, reward task difficulty, reward success, and/or the like. In some embodiments, baseline reward calculator 402 calculates a reward term that penalizes distance-to-goal through an SDF-based reward, which computes the distance between the current pose of the second part, such as the plug, and the goal (e.g., assembled) pose of the second part through SDF queries, which are less sensitive to object symmetries than keypoint-based distance queries. In some embodiments, baseline reward calculator 402 calculates a reward term that penalizes simulation error through a simulation-aware policy update (SAPU), which computes the maximum interpenetration distance at each timestep, weights the reward in inverse proportion to distance if the reward is less than a threshold, and does not update the reward otherwise. In some embodiments, baseline reward calculator 402 calculates a reward term that rewards task difficulty through a sampling-based curriculum (SBC), which increases the lower bound but not the upper bound of the range of initial-pose randomization as the robot becomes more proficient at the task and weights the return in proportion to task difficulty. In some embodiments, baseline reward calculator 402 calculates a reward term that rewards success with a bonus at the end of every horizon if the translational distance between the second part, such as the plug, and the goal falls below a threshold at any timestep.

Imitation reward calculator 403 calculates an imitation reward based on expert assembly data 124. In various embodiments, imitation reward calculator 403 calculates reward

$${R}_{t}^{{I}_{j}}$$

for a given assembly task that quantifies the instantaneous value of imitating any reversed disassembly path pᵢ′ included in expert assembly data 124. In some embodiments, Rₜ^{I}^{ᵢ} is calculated as the distance between the assembly path the robot has already traversed, and the reversed disassembly path pᵢ′ under consideration. In some embodiments, imitation reward calculator 403 uses a distance metric between paths that is insensitive to speed or sampling rate, such as dynamic time warping (DTW) or signature transforms. DTW is a dynamic programming algorithm for quantifying the difference between time series. Given two sequences a=[a¹, a², . . . , a^{P}] and b=[b¹, b², . . . , b^{Q}], DTW matches each aⁱ to one or more b^{j} and vice versa. The matching process minimizes a cost C(a, b) defined as the sum of Euclidean distances between each aⁱ and the corresponding match(es) from b. Furthermore, DTW satisfies constraints that 1) a¹ must match with at least b¹ (e.g., first points aligned), 2) a^{P} must match with at least b^{Q} (e.g., last points aligned), and 3) all matches must be monotonic (e.g., if aⁱ matches with b^{j}, then aⁱ⁺¹ cannot match with b^{j-1}, nor aⁱ⁻¹ with b^{j+1}). Ultimately, DTW returns the cost C*(a, b) of the optimal matches between a and b. Algorithm 1 provides pseudocode for a naive implementation of DTW.

Algorithm 1: Dynamic Time Warping (DTW)

| • | Require: Sequence a of length P and sequence b of length Q |
|---|---|
| • | Ensure: Returns DTW distance between a and bz |
| 1 | function DTWDISTANCE (a, b) |
| 2 | Define matrix M of shape (P + 1) × (Q + 1) |
| 3 | Initialize all elements of M to ∞ |
| 4 | Set M[0][0] ← 0 |
| 5 | for i ← 1 to P : |
| 6 | for j ← 1 to Q : |
| 7 | Compute d ←∥ a[i] − b[j] ∥₂ |
| 8 | Update |
| | M[i][j] ← d + min(M[i − 1][j],M[i][j − 1],M[i − 1][j − 1]) |
| 9 | end for |
| 10 | end for |
| 11 | return M[P][Q] |
| 12 | end function |

In Algorithm 1, a matrix M is constructed, where each M[i][j] describes the minimum cost of matching a[i] with b[j]. The implementation loops through each M[i][j] and assigns the value to the distance between a[i] and b[j], plus the minimum accumulated cost of all previous possible matches. Only 3 such accumulated costs need to be considered: the accumulated costs of matching a[i−1] and b[j], a[i] and b[j−1], and a[i−1] and b[j−1]. Intuitively, the accumulated costs are the only accumulated costs that 1) leave no previous point unmatched, and 2) are compliant with constraint 3. The value of element M[P][Q] is the final value assigned in the loop and represents the minimum accumulated cost C*(a, b) over all possible matches between a and b.

Signature transforms represent trajectories as a collection of path integrals called a path signature, which can also quantify distances between paths. In some embodiments, given a 3-dimensional path p(t)_{a,b}=(x₁(t), x₂(t), x₃(t))_{a,b}, where x₁(t), x₂(t), and x₃(t) represent x, y, and z coordinates for t∈[a, b], imitation reward calculator 403 calculates the path signature as a tensor of all possible path integrals between the coordinates. The first level of the path signature is

$${{S}_{1} ( {x}_{i} ( t ) )}_{a , t} = {\int }_{a}^{t} {dx}_{i} ( t ) = {x}_{i} ( t ) - {x}_{i} ( a ) , \qquad ( Equation 3 )$$

where i=1, 2, 3 (e.g., 3 total integrals), and the second level of the path signature is

$${{S}_{2} ( {x}_{i} ( t ) , {x}_{j} ( t ) )}_{a , t} = {\int }_{a}^{t} {{S}_{1} ( {x}_{i} ( t ) )}_{a , t} {dx}_{j} ( t ) , \qquad ( Equation 4 )$$

where i=1, 2, 3 and j=1, 2, 3 (e.g., 9 total path integrals). Further levels of the path signature can be derived in similar fashion. Finally, the full path signature is

$${S ( p ( t ) )}_{a , b} = ( 1 , {S}_{1} ( {{x}_{i} ( t )}_{a , b} ) , {{S}_{2} ( {x}_{i} ( t ) , {x}_{j} ( t ) )}_{a , b} , … ) , \qquad ( Equation 5 )$$

where all indices iterate over 1, 2, 3. The signature transform is simply the function T(p(t))_{a,b}:p(t)_{a,b}→S((p(t))_{a,b} that takes a path as input and outputs the path signature. Path signatures inherit translation and reparameterization invariance from path integrals. Signature transforms mitigate discretization sensitivity. In various embodiments, when imitation reward calculator 403 applies the signature transform, at each timestep t, imitation reward calculator 403 considers the full path pₑ(T)_{0,t} of the end effector from the beginning of the path. Then, for each reversed disassembly path pᵢ′ included in expert assembly data 124, imitation reward calculator 403 finds the closest point on pᵢ′ from the current point pₑ(t) on the end-effector path and extracts the segment of pᵢ′ between the start and the closest point. Imitation reward calculator 403 then calculates the path signatures S(pₑ(T))_{0,t} and S(pᵢ′) of the end-effector path and the disassembly path segment, respectively, and calculates the cost C(S(pₑ(T))_{0,t},S(pᵢ′)) between signatures as

$$C ( {S ( {p}_{e} ( T ) )}_{0 , t} , S ( {p}_{i}^{′} ) ) = {‖ {S ( {p}_{e} ( T ) )}_{0 , t} - S ( {p}_{i}^{′} ) ‖}_{2} . \qquad ( Equation 6 )$$

Finally, imitation reward calculator 403 calculates the reward as

$${R}_{t}^{{I}_{i}} = 1 - tan h C ( {S ( {p}_{e} ( T ) )}_{0 , t} , S ( {p}_{i}^{′} ) ) . \qquad ( Equation 7 )$$

In some embodiments, when the reverse disassembly trajectories included in expert assembly data 124 are defined as discrete paths, signature transforms represent trajectories as collections of discrete path sums, which can quantify distances between paths even when the data is not continuous. In some embodiments, given a three-dimensional path p[n]=(x[n], y[n], z[n]) for integer steps n∈[A, N], the first level of the discrete-time path signature can be expressed as

$${{S}_{1} ( x ( p [ n ] ) )}_{A , N} = {\sum }_{i = A}^{N - 1} ( x [ i + 1 ] - x [ i ] ) = x [ N ] - x [ A ] , \qquad ( Equation 8 )$$

and similarly for y[n] and z[n]. Higher-level terms accumulate pairwise (or higher) products of the increments. For example, the second level includes summing products of increments in multiple coordinates:

$$( Equation 9 )$$

$${{S}_{2} ( x ( p [ n ] ) , y ( p [ n ] ) )}_{A , N} = {\sum }_{i = A}^{N - 1} ( [ x [ i + 1 ] - x [ i ] ] \cdot [ y [ i + 1 ] - y [ i ] ] ) ,$$

and so on, creating a signature vector that is invariant to translation and reparameterization. In various embodiments, imitation reward calculator 403 applies the discrete signature transform at each timestep t to the entire end-effector path pₑ[t] observed so far. In general, the i th level of the discrete-time path signature includes 3ⁱ path summations, capturing increasingly rich features of the reverse disassembly trajectory. The full discrete-time path signature can thus be written as

$${S ( p [ n ] )}_{A , B} = ( 1 , {{S}_{1} ( p [ n ] )}_{A , B} , {{S}_{2} ( p [ n ] )}_{A , B} , … ) , \qquad ( Equation 10 )$$

where each Sₖ(p[n])_{A,B} groups together all level-k increments (e.g.,

$${\sum }_{i = A}^{B - 1} [ x [ i + 1 ] - x [ i ] ] [ y [ i + 1 ] - y [ i ] ]$$

for a pairwise term). For each reversed disassembly path pᵢ′ from expert assembly data 124, imitation reward calculator 403 finds the segment of pᵢ′ closest to pₑ[t] and calculates the cost

$$C ( S ( {p}_{e} [ t ] ) , S ( {p}_{i}^{′} ) ) = {‖ S ( {p}_{e} [ t ] ) - S ( {p}_{i}^{′} ) ‖}_{2} , \qquad ( Equation 10 )$$

where S(pₑ[t]) and S(pᵢ′) are the discrete path signatures of the end-effector path and the reversed disassembly path, respectively. The imitation reward for demonstration i is then defined by

$${R}_{t}^{{I}_{i}} = 1 - tanh ( C ( S ( {p}_{e} [ t ] ) , S ( {p}_{i}^{′} ) ) ) , \qquad ( Equation 11 )$$

so that smaller signature distances (more similar trajectories) yield higher rewards. In some embodiments, imitation reward calculator 403 applies a discrete path signature at every timestep, then uses a fast, GPU-based signature transform, such as Signatory, to compute similarity metrics between the current end-effector path and reversed disassembly paths included in expert assembly data 124. In some embodiments, imitation reward

$${R}_{t}^{I}$$

is defined as the maximum per-timestep imitation reward over all reversed disassembly paths i=1, . . . , M included in expert assembly data 124 described as

$${R}_{t}^{I} = {max}_{i = 1 , … , M} {R}_{t}^{{I}_{i}} . \qquad ( Equation 12 )$$

In various embodiments, specialist reward calculator 117 uses baseline reward and imitation reward to calculate reward 408. In some examples, specialist reward calculator 117 calculates reward 408 as

$${R}_{t} = {ω}^{B} {R}_{t}^{B} + {ω}^{I} {R}_{t}^{I} , \qquad ( Equation 13 )$$

where

$${R}_{t}^{B}$$

is the baseline reward,

$${R}_{t}^{I}$$

is the imination reward, anu ω^{B} and ω^{I} are weighting hyperparameters.

Model trainer 115 uses reward 408 and critic evaluations to train specialist critic models 121 and specialist actor models 122. As shown, model trainer 115 includes a reinforcement learning module 401. Reinforcement learning module 401 processes reward 408 and critic evaluations to iteratively update the one or more parameters of specialist critic models 121 and specialist actor models 122. In various embodiments, the robotic assembly problem is formulated as a Markov decision process (MDP), where the agent is a simulated robot, and the environment is a simulated environment containing the parts to be assembled. The MDP includes a state space S, an observation space [symbol] , and an action space [symbol] . The state-transition dynamics are defined by [symbol] : [symbol] × [symbol] → [symbol] , which is governed by the physical laws of rigid-body dynamics implemented in simulator 116. In some embodiments, reinforcement learning module 401 uses a randomized initial state distribution po and reward function R: [symbol] → [symbol] with discount factor γ∈(0,1]. Reinforcement learning module 401 constrains each agent to execute actions over episodes of length N timesteps and defines shorter learning horizons of length T timesteps. Finally, reinforcement learning module 401 defines a total return G described as

$$G ( T ) = {𝔼}_{π} [ {\sum }_{t = 0}^{T - 1} {γ}^{t} R ( {s}_{t} ) ] , \qquad ( Equation 14 )$$

which is the total return in terms of the expected sum of discounted rewards over the horizon. For example, the total return over each horizon can be given as

$$G ( T ) = {w}_{SBC} {\sum }_{t = 0}^{T - 1} ( {ω}_{SAPU} ( {ω}_{SDF} {R}_{SDF} + {ω}_{1} {R}_{1} ) ) + {R}_{succ} , \qquad ( Equation 15 )$$

where w_{SBC} is the weighting factor based on the assembly task difficulty, as determined by the SBC algorithm, ω_{SAPU} is the weighting factor based on simulation error, as determined by the SAPU algorithm, R_{SDF} is the distance-to-goal reward, as determined by the SDF-based reward, R_{I} is the imitation reward, ω_{SDF} and ω_{I} are hyperparameters to determine the relative importance of the distance-to-goal reward and the imitation-based reward, and R_{succ} is a success bonus applied at the end of each horizon. In some examples, reinforcement learning module 401 tunes parameters ω_{SDF} and ω_{I} so that R_{SDF} and R_{I} fall within the same order of magnitude. The objective of reinforcement learning module 401 is to train policies π: [symbol] → [symbol] ( [symbol] ), mapping specialist actor observations 406 to a probability distribution over specialist actor actions 405, that maximizes the total return as given in Equation 14. In some embodiments, reinforcement learning module 401 uses various optimization algorithms including but not limited to the proximal policy optimization (PPO) algorithm to train specialist actor models 122 and specialist critic models 121. In some embodiments, reinforcement learning module 401 mitigates the low sample efficiency of PPO by using GPU-accelerated SDF-based contact simulation and a GPU-accelerated PPO implementation. In some embodiments, reinforcement learning module 401 uses PPO to learn a stochastic policy ϕ_{θ} (e.g., specialist actor model 122) parameterized by a neural network with weights θ, as well as an approximation of the on-policy value function V_{ϕ}: [symbol] → [symbol] (e.g., specialist critic model 121) parameterized by a neural network with weights ϕ. In various embodiments, at evaluation and deployment time, policy ϕ_{θ} is deterministic, and V_{ϕ} is neglected. In some examples, PPO parameters are set to an Adam learning rate of 1×10⁻⁴, a discount factor γ of 0.99, a generalized advantage estimation (GAE) parameter of 0.95, and a minibatch size of 8192. In some embodiments, the entropy coefficient can be set to 0.0, the critic coefficient to 0.2, and the clipping parameter ε̅ to 0.2. In various embodiments, model trainer 115 trains specialist actor models 122 and specialist critic models 121 until a stopping criterion is met. For example, model trainer 115 can stop training once a maximum number of iterations or episodes has been reached. In some embodiments, model trainer 115 stops training when a performance threshold is met, such as achieving a desired insertion success rate, minimizing a distance-to-goal metric, maintaining low interpenetration with the socket for a set number of trials, and/or the like. In some embodiments, model trainer 115 stops training whenever the performance of policy Tte plateaus or begins to degrade over multiple iterations. Once model trainer 115 trains specialist actor models 122, model trainer 115 stores the trained specialist actor models 122 in datastore 120 or elsewhere.

FIG. 4B illustrates how the model trainer 115 trains a generalist actor model 123, according to various embodiments. As shown, model trainer 115 uses the trained specialist actor models 122 to train generalist actor model 123. In operation, simulator 116 generates one or more specialist actor observations 406. The trained specialist actor models 122 generate specialist actor actions 405. Simulator 116 processes specialist actor actions 405 and generates demonstration data 414. Simulator 116 then uses demonstration data 414 to generate generalist actor observations 407. Generalist actor model 123 processes part geometries 411 and generalist actor observations 407 and generates generalist actor actions 412. Generalist loss calculator 118 uses behavior cloning loss calculator 410 to process demonstration data 414 and generalist actor actions 412 and compute behavior cloning loss 413. Model trainer 115 uses behavior cloning loss 413 to iteratively train generalist actor model 123.

Generalist actor model 123 processes part geometries 411 and generalist actor observations 407 to generate generalist actor actions 412. Part geometries 411 include data, such as bounding boxes, polygon meshes, or CAD-based representations for both the first part and the second part. Part geometries 411 include dimensions (e.g., height, width, clearance), shape descriptors (e.g., curvature profiles, contact surfaces), or metadata about tolerances and insertion axes. In various embodiments, generalist actor model 123 includes a pretrained neural network to extract a latent representation of part geometries 411 and generate a latent vector. In some embodiments, the pretrained neural network includes an autoencoder, which is trained on a large set of meshes M. Each mesh mᵢ∈M consists of (Vᵢ, Eᵢ), where V are the vertices and E are the (undirected) edges. During pretraining, at each iteration, a batch of meshes B⊂M are sampled. For each mᵢ∈B, a point cloud Pᵢ is sampled online, with each point

$${p}_{i}^{j}$$

∈Pᵢ lying on the surface of mᵢ. The point cloud Pᵢ is passed to an encoder, such as a PointNet encoder, to generate a latent vector zᵢ. Vector zᵢ is passed to a fully-convolutional decoder to generate a reconstructed point cloud Qᵢ. The pretrained network is trained to minimize reconstruction loss, for example, defined as the chamfer distance between Pᵢ and Qᵢ:

$${L}_{CD} = \frac{1}{\vert {P}_{i} \vert} {\sum }_{p ∈ {P}_{i}} {min}_{q ∈ {Q}_{i}} {‖ p - q ‖}_{2}^{2} + \frac{1}{\vert {Q}_{i} \vert} {\sum }_{q ∈ {Q}_{i}} {min}_{p ∈ {P}_{i}} {‖ p - q ‖}_{2}^{2} , \qquad ( Equation 16 )$$

In some examples, |M|=1000 meshes, N=2000, and |zᵢ|=32. In some embodiments, the mean and variance of the vertices Vᵢ for each mesh mᵢ prior to pretraining are normalized, such that the network is not biased by a non-uniform distribution of mesh sizes. In some embodiments, the depth of the encoder relative to the decoder is increased, such that the encoder can learn a more abstract latent representation, whereas the decoder is discouraged from overfitting to the input data. In some embodiments, the autoencoder is trained with explicit or implicit surface information, which may improve the success rate of the generalist policy, such as by augmenting each point

$${p}_{i}^{3}$$

with the local surface normal, using a graph neural net (e.g., a graph convolutional network) that takes both points and edges as input, learning low-dimensional SDF representations of the parts, and/or the like. In various embodiments, for a given assembly task, the latent vectors for the second part zₚ and the first part zₛ are concatenated before processing. In various embodiments, generalist actor observations 407 and generalist actor actions 412 are similar to specialist actor observations 406 and specialist actor actions 405, respectively. In some embodiments, generalist actor observations 407 include observation noise. For example, the X, Y, and Z positions of the pose of the first part, such as the socket, can each be perturbed by a uniform random value in the range [−2, 2] mm, while roll, pitch, and yaw angles of the first part could each be perturbed by values in the range of [−5, 5] degrees. The noise values can be sampled from uniform distributions, causing small deviations in the perceived position and orientation of the first part. In some embodiments, generalist actor model 123 includes various neural network layers, including but not limited to MLP networks and LSTM networks. Generalist actor actions 412 can be used to perform at least part of a plurality of robotic assembly tasks.

Simulator 116 processes specialist actor actions 405 and generates specialist actor observations 406, generalist actor observations 407, and demonstration data 414. In various embodiments, simulator 116 executes each trained specialist policy Its mapping specialist actor observations 406 to specialist actor actions 405 under initial-pose randomization and generates specialist actor observations 406 until completing a fixed number (e.g., 5000) of successful episodes. For each successful episode, simulator 116 generates the state-action pairs as a demonstration

$${D}_{i} = \{ ( {s}_{i}^{1} , {a}_{i}^{1} ) , ( {s}_{i}^{2} , {a}_{i}^{2} ) , … , ( {s}_{i}^{{N}_{i}} , {a}_{i}^{{N}_{i}} ) \}$$

included in demonstration data 414, where is

$${s}_{i}^{j}$$

is jth specialist actor observation 406 of the ith demonstration,

$${a}_{i}^{j}$$

is the corresponding specialist actor action 405, and Nᵢ denotes the length of the ith demonstration with i=1, 2, . . . , M (e.g., M=128). Simulator 116 then generates generalist actor observations 407 based on demonstration data 414. In various embodiments, simulator 116 generates generalist action observations 407 based on the states

$${s}_{i}^{1} , {s}_{i}^{2} , … , {s}_{i}^{{N}_{i}}$$

included in demonstration data 414.

Generalist loss calculator 118 processes demonstration data 414 and generalist actor actions 412 to generate behavior cloning loss 413. As shown, generalist loss calculator 118 includes, without limitation, behavior cloning loss calculator 410. In some examples, behavior cloning loss calculator 410 calculates behavior cloning loss 413 as

$$ℒ = \frac{1}{M} {\sum }_{i = 1}^{M} {\sum }_{j = 1}^{{N}_{i}} {( {a}_{i}^{j} - {π}_{g} ( {s}_{i}^{j} ) )}^{2} , \qquad ( Equation 17 )$$

where

$${π}_{g} ( {s}_{i}^{j} )$$

denotes the generalist actor action 412 corresponding to the jth specialist actor observation 406 of the ith demonstration.

Model trainer 115 trains generalist actor model 123 based on behavior cloning loss 413. In various embodiments, model trainer 412 initializes parameters of generalist policy (e.g., generalist actor model 123) π_{g} randomly. In various embodiments, at every training epoch, model trainer 115 samples batches of demonstration data 414. For each batch, model trainer 115 uses various optimization approaches, such as stochastic gradient descent, adaptive moment estimation (Adam), and/or the like, to update one or more parameters of generalist actor model 123 so that the behavior cloning loss 413 is minimized. In some embodiments, training terminates once a predefined number of epochs has been reached (e.g., 1,000 epochs). In other embodiments, training stops when the behavior cloning loss 413 fails to improve by a minimum threshold over a certain window of epochs, indicating that the model parameters have converged. In some embodiments, model trainer 115 uses a validation metric, such as the success rate of assembly tasks in a small test set, to trigger early termination of training when the validation metric reaches or surpasses a target value.

FIG. 4C illustrates how the model trainer 115 of FIG. 1 re-trains the generalist actor model 123 of FIG. 4B, according to various embodiments. As shown, model trainer 115 uses trained specialist actor models 122 to re-train the trained generalist actor model 123. In operation, simulator 116 generates generalist actor observations 407. Trained generalist actor model 123 processes part geometries 411 and generalist actor observations 407 and generates generalist actor actions 412. Simulator 116 processes generalist actor actions 412 and generates specialist actor observations 406 and DAgger data 415. Trained specialist actor models 122 process specialist actor observations 406 and generate specialist actor actions 405. Generalist loss calculator 118 uses DAgger loss calculator 421 to process specialist actor actions 405 and DAgger data 415 to generate DAgger loss 420. Model trainer 115 uses DAgger loss 420 to iteratively re-train the trained generalist actor model 123. Once generalist actor model 123 is re-trained, model trainer 115 can optionally use reinforcement learning module 401 to re-train generalist actor model 123.

As described, simulator 116 processes generalist actor actions 405 and generates specialist actor observations 406, generalist actor observations 407, and DAgger data 415. In various embodiments, simulator 116 executes each trained generalist policy π_{g} mapping generalist actor observations 407 to generalist actor actions 412 and generates generalist actor observations 407, specialist actor observations 406, and DAgger data 415 until completing a fixed number (e.g., 256) of successful episodes. For each successful episode, simulator 116 generates the state-action pairs

$$\{ ( {s}_{i}^{j} , {a}_{i}^{j} ) \}$$

included In DAgger data 415, where

$${s}_{i}^{j}$$

is the state visited by the trained generalist actor model 123, and

$${a}_{i}^{j} = {π}_{s} ( {s}_{i}^{j} )$$

is the corresponding specialist actor action 405.

DAgger loss calculator 118 processes specialist actor actions 405 and DAgger data 415 and generates DAgger loss 420. As shown, generalist loss calculator 118 includes, without limitation, DAgger loss calculator 421. In some examples, DAgger loss calculator 415 calculates DAgger loss 420 as

$$ℒ = \frac{1}{M} {\sum }_{i = 1}^{M} {\sum }_{j = 1}^{{N}_{i}} {( {π}_{g} ( {s}_{i}^{j} ) - {π}_{s} ( {s}_{i}^{j} ) )}^{2} , \qquad ( Equation 18 )$$

which measures the discrepancy between generalist actor actions 412 at states

$${s}_{i}^{j}$$

and the specialist actor actions 405 queried at same states

$${s}_{i}^{j} .$$

Model trainer 115 re-trains generalist actor model 123 based on DAgger loss 415. In various embodiments, at every training epoch, model trainer 115 samples batches of DAgger data 415. For each batch, model trainer 115 uses various optimization approaches, such as stochastic gradient descent, Adam, and/or the like, to update one or more parameters of the trained generalist actor model 123 so that the DAgger loss 415 is minimized. In some embodiments, training terminates once a predefined number of epochs has been reached. In other embodiments, training stops when the DAgger loss 415 fails to improve by a minimum threshold over a certain window of epochs, indicating that the model parameters have converged. In some embodiments, model trainer 115 uses a validation metric, such as the success rate of assembly tasks in a small test set, to trigger early termination of training when the validation metric reaches or surpasses a target value.

In some embodiments, once generalist actor model 123 is re-trained, model trainer 115 optionally re-trains generalist actor model 123 using reinforcement learning module 401. In some embodiments, reinforcement learning module 401 begins the re-training with the re-trained generalist actor model 123 π_{g}′ and follows a baseline reinforcement learning procedure, such as with the total return over each horizon described in Equations 14 and 15. In some embodiments, model trainer 115 uses a sampling-based curriculum (SBC), where the agent (e.g., the retrained generalist actor model 123) is exposed to the full range of initial-pose randomization at the start of the curriculum, but increases the lower bound at each stage. In some examples, at each curriculum stage k=1, . . . , K, the initial height of the second part (e.g., the plug) is sampled from a uniform distribution

$${h}_{k}^{i n i t} ∼ U [ {h}_{k}^{min} , {h}^{max} ] ,$$

where

$${h}_{k}^{min} < {h}_{max} , {h}_{1}^{i n i t} \leq {h}_{k}^{i n i t} \leq {h}_{K}^{init} ,$$

and h^{max} remains constant.

FIG. 5 is a more detailed illustration of the robot control application 146 of FIG. 1, according to various embodiments. Robot control application 146 uses the trained generalist actor model 123 to process sensor data 502 and part geometries 500 and generate one or more controls for robot 160 to perform at least part of a robotic assembly task. As shown, robot control application 146 includes, at least, a sensor data processing module 501 and the trained generalist actor model 123.

Sensor data processing module 501 processes sensor data 502 and generates one or more generalist actor observations 407. In various embodiments, each part included in the assembly task has a known CAD model, such as an object (OBJ) file with no associated texture and/or the like, which is included in part geometries 500. In some embodiments, sensor data processing module 501 includes a pose estimation pipeline that processes an RGB and depth (RGB-D) image of parts, intrinsics matrix of a camera included in sensors 180, and extrinsics matrix of the camera, and a CAD model of the parts, and generates the 6-dimensional pose of the parts included in generalist actor observations 407. In some examples, the camera is used to capture a 1280×720 RGB image and 1280×720 depth image of a part with a known CAD model. The RGB image is shown to a user, and the user can provide one or more inputs (not shown), such as mouse clicks, natural language, and/or the like, to select the part to provide a positive annotation (e.g., a pixel that lies on the part of interest). In some embodiments, sensor data processing module 501 includes a segmentation algorithm which processes the RGB image of the part, pixel location(s), and annotation(s) and generates a segmentation mask for the part. In some examples, whenever the mask does not span the part, the user can optionally provide another positive annotation. Whenever the mask includes background features, the user can provide a negative annotation (e.g., a pixel that does not correspond to the part). The segmentation algorithm is then executed to generate additional annotation. In some embodiments, sensor data processing module 501 includes a model-based estimation algorithm, which processes the RGB image, the depth image, camera intrinsics, segmentation mask, and part CAD model and generates the 6-dimensional object pose in the camera frame. In some embodiments, sensor data processing module 501 combines the 6-dimensional object pose in the camera frame with the camera extrinsics to compute the 6D object pose in the robot frame.

Robot control application 146 uses the trained generalist actor model 123 to generate one or more controls for robot 160 to perform at least part of a robotic assembly task. In various embodiments, the trained generalist actor model 123 processes part geometries 500 and generalist actor observations 407 and generates one or more generalist actor actions 412, which include target poses and velocities of end-effector of robot 160. In some embodiments, robot control application 146 includes a task-space impedance controller that processes generalist actor actions 412 and generates one or more controls. In some examples, the task-space impedance controller computes joint torques t using the relationship

$$τ = {J}^{T} {K}_{p} ( {x}_{t} ⊖ {x}_{c} ) - {K}_{d} {x}_{c} , \qquad ( Equation 19 )$$

where J× [symbol] is the geometric Jacobian, Kₚ∈ [symbol] and K_{d}∈ [symbol] are diagonal matrices containing proportional and derivative gains, respectively, x_{c}∈ [symbol] is the current velocity vector of the end-effector of robot 160, and xₜ⊖x_{c} represents the incremental pose target. The target pose xₜ∈ [symbol] is the desired position and orientation of the end-effector of robot 160 in the task space. In some embodiments, robot control application 146 includes a superimposed nullspace controller to softly enforce a constraint on the configuration of robot 160, permitting high manipulability and mitigating undesirable effects, such as elbow drift.

FIG. 6 is a flow diagram of method steps for generating expert assembly data 124, according to various embodiments. Although the method steps are described in conjunction with the systems of FIGS. 1-5, persons skilled in the art will understand that any system configured to perform the method steps in any order falls within the scope of the present disclosure.

As shown, a method 600 begins with step 601, wherein simulator 301 is initialized. In various embodiments, the initialization of simulator 301 includes setting up robot model 308, simulation environment 307, and initial conditions for the robotic assembly task. In various embodiments, simulator 301 first assigns initial joint angles Θ⁰ to the robot, which determines the starting end-effector pose

$${X}_{E E}^{0}$$

as described in Equation 1. In some embodiments, the initial poses of the second part

$${X}_{P}^{0}$$

and the first part

$${X}_{S}^{0}$$

are sampled from uniform distributions, such that the convex hulls of the second part and the first part, M_{P} and M_{S}, do not interpenetrate in ways that prevent valid assembly. In addition to sampling initial poses, simulator 301 initializes physical parameters, including contact friction coefficients, mass properties, and force limits for both the robot and the assembly parts. In some embodiments, simulation environment 307 included in simulator 301 loads a precomputed SDF-based collision model. Once all initial conditions are set, simulator 301 applies an initial control target U(0) as described in Equation 2, which specifies either a desired joint-space configuration Θ⁰ or a task-space target

$${X}_{E E}^{0} .$$

The control gains, denoted as Kₚ and K_{d}, as defined in Equation 2 are also initialized.

At step 602, part geometry data preparation module 302 generates prepared part geometry data based on part geometry data 125. In various embodiments, part geometry preparation module 302 applies one or more mesh manipulations to permit feasibility in simulation or real-world assembly. The manipulations include scaling unitless meshes so the bounding box aligns with typical robot work envelopes, reorienting each part so the primary assembly axis corresponds to a global axis, and translating the mesh so the bottom surface is coplanar with the global origin, and/or the like. In scaling unitless meshes, part geometry data preparation module 302 can, for example, choose units of meters, draw an oriented bounding box, and scale the part mesh such that the longest edge of the bounding box is at a fixed length (e.g., 10 cm), allowing the part to be grasped by robotic manipulators. In reorientation, geometry data preparation module 302 reorients the mesh such that the primary axis of assembly (e.g., the insertion direction) is aligned with the global z-axis. In translation, part geometry data preparation module 302 translates the part mesh such that the bottom surface of the part mesh is coplanar with the global origin when the part mesh is in an assembled state. In some embodiments, part geometry data preparation module 302 prepares part meshes for depenetration and clearance by shifting vertices to achieve a desired radial gap between two parts, such as a plug and socket. In some examples, when the part mesh is a plug, part geometry data preparation module 302 temporarily instantiates the corresponding socket. For each vertex on the plug, part geometry data preparation module 302 computes a signed distance to the socket along the vertex normal. If the distance is negative corresponding to interpenetration or less than a desired radial clearance (e.g., 0.5 mm), part geometry data preparation module 302 translates the vertex backward along the normal until achieving the desired clearance. In some embodiments, when the latter procedure produces unexpected results, such as when the plug is very thin or the socket is hollow, part geometry data preparation module 302 can prompt a user to perform manual corrections via a user interface. In some embodiments, part geometry data preparation module 302 optionally chamfers contact edges to reduce burrs and ease insertion. In some examples, part geometry data preparation module 302 chamfers the contacting edges of a plug and socket. Both chamfered and unchamfered versions of part meshes are included in the prepared part geometry data. In some embodiments, part geometry data preparation module 302 subdivides the part meshes included in part geometry data 125 to generate sufficient vertices for stable collision modeling. In some examples, part geometry data preparation module 302 subdivides the part meshes until generating a minimum number of vertices (e.g., 2000 vertices).

At step 604, grasp sampling module 304 generates grasp sample 312 based on prepared part geometry data. In various embodiments, the robot in simulator 301 has to first grasp the second part, such as the plug, before assembling or disassembling the second part and socket, and the success of the assembly or disassembly process depends on the quality of the grasp. For each assembly, grasp sampling module 304 performs a grasp optimization procedure to determine a grasp that leads to a high probability of success during assembly or disassembly. The grasp optimization procedure includes two steps of grasp sampling and physics-based evaluation. In the grasp sampling step, grasp sampling module 304 uses a kinematics and geometry-based grasp sampling approach. For each assembly, grasp sampling module 304 first initializes the meshes of the second part and the first part in the assembled state. Grasp sampling module 304 instantiates a robot gripper mesh, randomly samples a surface normal on the mesh of the second part, and aligns the central axis of the gripper to be collinear with the surface normal. Grasp sampling module 304 then randomly samples a position along the normal and translates the gripper to the position along the normal. Grasp sampling module 304 then generates the grasp sample 312 as the 6-DOF pose of the gripper. In some embodiments, grasp sampling module 304 selects a grasp sample 312 (e.g., grasp pose) from various candidate grasp samples (e.g., candidate grasp poses) and rejects a grasp sample candidate if 1) the robot hand intersects the meshes of the first part or the second part, 2) the mesh of the second part does not intersect the gripper closing region (e.g., the prismatic volume contained between the fully-opened gripper fingers), or 3) the Euler angles of the gripper are outside of specified bounds (e.g., [−15, 15] degrees for roll and pitch and [−120, 120] degrees for yaw) to ensure that the robot remains in a region of the workspace with high manipulability. In some embodiments, grasp sampling module 304 repeats the steps of grasp sampling until generating a fixed number of (e.g., 100) grasp samples 312. In the physics-based evaluation step, grasp sampling module 304 performs physics-based evaluations to guarantee the grasp samples 312 to be stable during the contact-rich interactions experienced during assembly and disassembly. For each assembly, grasp sampling module 304 first randomizes the pose of the first part, such as a socket, over a wide range, and grasp sampling module 304 initializes the second part, such as a plug, in the assembled state (e.g., inserted in the first part). For each of the grasp samples 312 in the grasp sampling step, grasp sampling module 304 executes the grasp on the second part using simulator 301. Grasp sampling module 304 then uses a task-space impedance controller to lift the second part from the socket until the convex hull of the second part no longer intersects the convex hull of the first part, and grasp sampling module 304 moves the robot gripper to a pose in free space randomly sampled from specified bounds (e.g., [−0.05, 0.05] for X- and Y-position, [0, 0.05] for Z-position, and [−10, 10] deg for roll, pitch, and yaw). In some embodiments, grasp sampling module 304 checks whether the grasp is successful (e.g., if the plug remains in the gripper fingers until the end of the assembly procedure). In various embodiments, grasp sampling module 304 repeats the physics-based evaluation step for a fixed number of times (e.g., 1000 times). Finally, grasp sampling module 304 identifies the grasp sample 312 with the highest success rate and designates that grasp sample 312 as the highest-performing grasp for the given assembly task. In various embodiments, grasp sampling module 304 generates grasp sample 312 as a dictionary that maps each assembly task to the highest-performing grasp for the corresponding second part.

At step 604, environment randomization module 303 generates randomized assembly state 311 based on grasp sample 312. In various embodiments, environment randomization module 303 randomizes the robot and the states of the first part as well as the states of the second part in the robot gripper. In some embodiments, environment randomization module 303 first randomizes the position of the first part, such as a socket, and orientation within specified ranges (e.g., x∈[0.40, 0.60] m, y∈[−0.10, 0.10] m, z∈[0.16, 0.18] m, and roll/pitch/yaw∈[−5, 5] deg). Next, the pose of the second part, such as a plug, is randomized relative to the first part from fixed intervals (e.g., x∈[−10, 10] mm, y∈[−10, 10] mm, z∈[10, 20] mm, and roll/pitch/yaw∈[−5, 5] deg). Environment randomization module 303 then moves the robot gripper near the pose of the second part and optionally applies a second stage of randomization for x, y, z, roll, pitch, and yaw relative to the gripper from a fixed interval (e.g., ∈[−5, 5] deg for orientations). Environment randomization module 303 samples the values for first part position and orientation, second part pose, and second part pose relative to the gripper of the robot from uniform distributions to generate diverse initial conditions. Environment randomization module 303 also generates a goal state included in randomized assembly state 311 by inserting each second part into the corresponding first part. In various embodiments, environment randomization module 303 modifies initial states included in randomized assembly state 311 for custom applications.

At step 605, disassembly trajectory generator 305 generates disassembly trajectories 313 based on randomized assembly state 311. In various embodiments, disassembly trajectory generator 305 simulates grasp sample 312 and randomized assembly state 311 in simulator 301 to generate disassembly trajectories 313. As described, in some embodiments, generating the disassembly trajectories can include using a task-space impedance controller to lift the grasped part from a socket until the convex hull of the grasped part no longer intersects the convex hull of the socket, then moving the robot gripper to a pose in free space that is randomly sampled from specified bounds. In some other embodiments, the disassembly can be performed along any suitable direction (as opposed to the up-down direction), such as along a direction specified by a directional vector. Although described herein primarily with respect to disassembling a plug from a socket as a reference example, any suitable disassembly can be performed in some embodiments, such as a disassembly that involves iteratively moving the grasped part in the x, y, z, and rotational directions to find a direction that works for the disassembly, and trying another direction if a direction does not work.

At step 606, trajectory reversion module 306 generates expert assembly data 124 based on disassembly trajectories 313. In various embodiments, trajectory reversion module 306 generates expert assembly data 124 by reversing disassembly trajectories 313 Dᵢ′ described as

$${x}_{i}^{′} = [ {x}_{i}^{{N}_{i}} , {x}_{i}^{{N}_{i} - 1} , … , {x}_{i}^{1} ] ,$$

which can naively be used as an assembly demonstration. In various embodiments, since the corresponding velocities

$${v}_{i}^{′} = [ {v}_{i}^{{N}_{i}} , {v}_{i}^{{N}_{i} - 1} , … , {v}_{i}^{1} ]$$

and accelerations

$${a}_{i}^{′} = [ {a}_{i}^{{N}_{i}} , {a}_{i}^{{N}_{i} - 1} , … , {a}_{i}^{1} ]$$

are in general nonphysical, the velocities and accelerations are not included in expert assembly data 124. Then, for each successful trial, trajectory reversion module 306 includes only the reversed disassembly positions (e.g., paths)

$${p}_{i}^{′} = [ {p}_{i}^{{N}_{i}} , {p}_{i}^{{N}_{i} - 1} , … , {p}_{i}^{1} ]$$

in the expert assembly data 124.

At step 607, expert assembly data generator 119 checks whether to continue generating expert assembly data 124. If expert assembly data generator 119 determines to continue generating expert assembly data 124, the method 600 proceeds to step 604. If expert assembly data generator 119 determines not to continue generating expert assembly data 124, the method 600 terminates and expert assembly data generator 119 stores expert assembly data 124 in data store 120 or elsewhere.

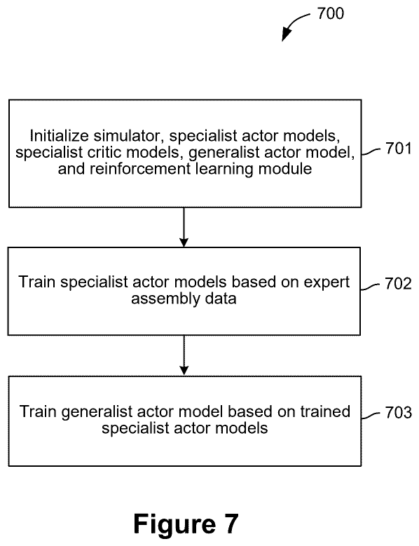

FIG. 7 is a flow diagram of method steps for training the generalist actor model 123, according to various embodiments. Although the method steps are described in conjunction with the systems of FIGS. 1-5, persons skilled in the art will understand that any system configured to perform the method steps in any order falls within the scope of the present disclosure.

As shown, a method 700 begins with step 701, where model trainer 115 initializes simulator 116, specialist actor models 122, specialist critic models 121, generalist actor model 123, and reinforcement learning module 401. In various embodiments, simulator 116 loads the robot model and simulation environment, defining the dynamics of the robotic system and the assembly parts. The initial conditions, including the positions and orientations of the robot, a first part, and a second part, are sampled from predefined distributions to permit a diverse training dataset. In some embodiments, specialist actor models 122 and specialist critic models 121 are initialized with random parameters. Generalist actor model 123 is also initialized with random parameters. In some embodiments, reinforcement learning module 401 is initialized. In some embodiments, PPO hyperparameters for training, including an Adam learning rate (e.g., 1×10⁻⁴), a discount factor γ (e.g., 0.99), and a GAE parameter λ(e.g., 0.95) are initialized. The PPO clipping parameter ∈ is set (e.g., 0.2), and the critic coefficient is set (e.g., 2), permitting stability in value function updates. The entropy coefficient is set (e.g., 0.0) to prevent excessive exploration in the learned policies. In some embodiments, minibatch sizes are initialized (e.g., 8192), with a fixed number of minibatch epochs (e.g., 8 epochs) per training iteration to optimize convergence efficiency. In some embodiments, the number and type of layers in specialist actor models 122 and specialist critic models 121 are initialized. For example, specialist actor models 122 could each be initialized as a neural network including an MLP with three fully connected layers. As a specific example, specialist actor models 122 and specialist critic models 121 could be initialized with layers sized [256, 128, 64], while generalist actor model could can be initialized with layer sizes [512, 256, 128, 64]. In some examples, specialist actor models 122 and generalist actor model 123 can be initialized with a LSTM layer of size 256 to capture temporal dependencies in sequential decision-making.

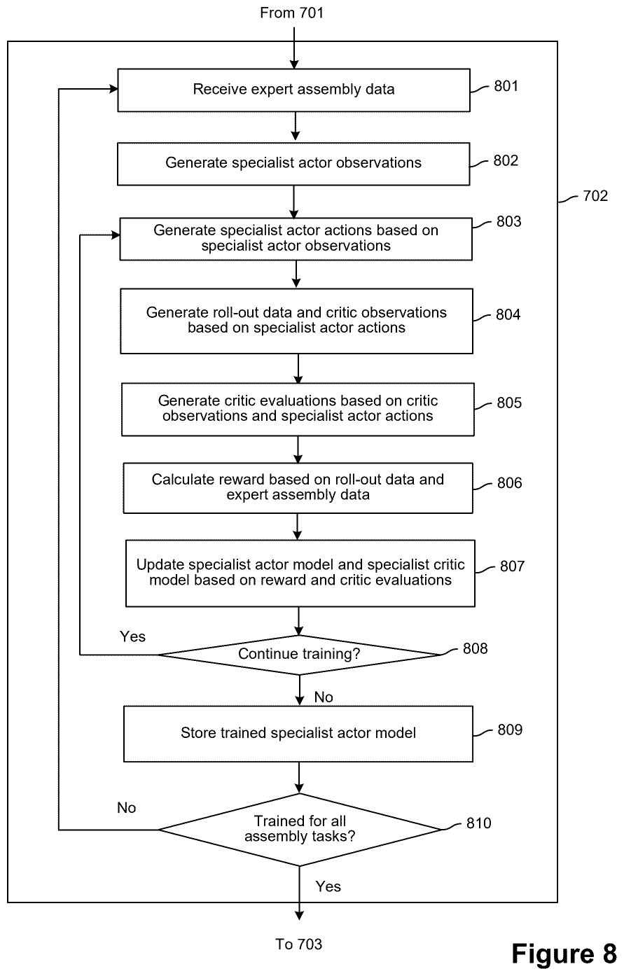

At step 702, model trainer 115 trains specialist actor models 122 based on expert assembly data 124. In various embodiments, simulator 116 generates one or more specialist actor observations 406. Specialist actor models 122 process specialist actor observations 406 and generate specialist actor actions 405, which are applied to simulator 116 to generate new specialist actor observations 406 and critic observations 404. Specialist critic models 121 evaluate specialist actor actions 405 using the critic observations 404 and generate critic evaluations. Simulator 116 then generates roll-out data 407, which includes robot and parts states as well as specialist actor observations 406. Specialist reward calculator 117 calculates reward 408 based on the roll-out data 407 and expert assembly data 124. Reinforcement learning module 401 then updates one or more parameters of specialist actor models 122 and specialist critic models 121 based on reward 408 and critic evaluations iteratively, until a stopping criterion is met. Step 702 is described in more detail in conjunction with FIG. 8.

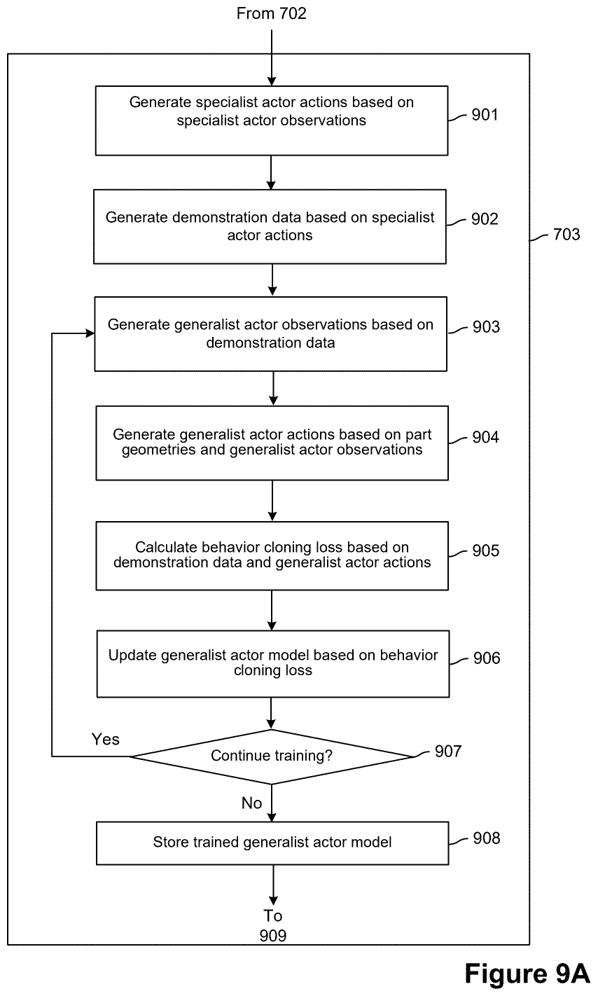

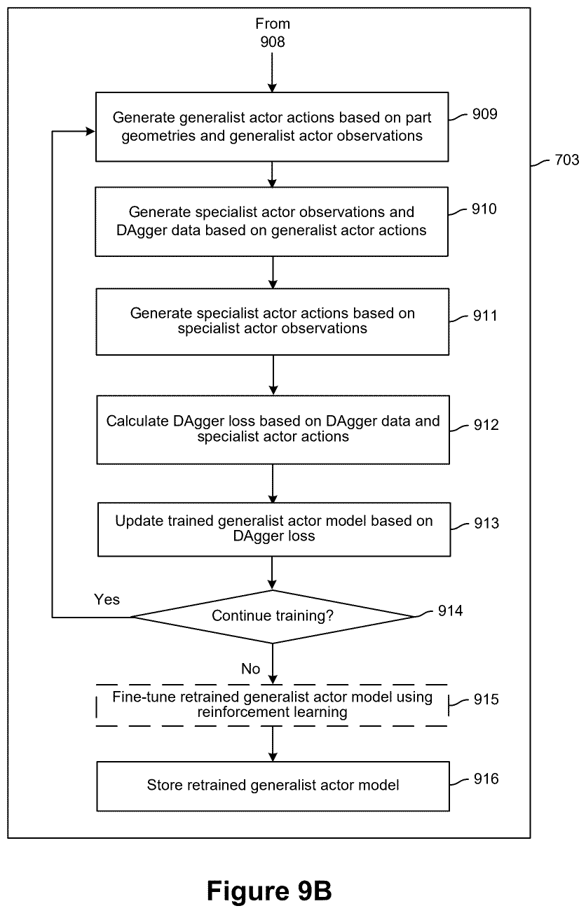

At step 703, model trainer 115 trains generalist actor model 123 based on trained specialist actor models 122. In various embodiments, simulator 116 generates one or more specialist actor observations 406. The trained specialist actor models 122 generate specialist actor actions 405. Simulator 116 processes specialist actor actions 405 and generates generalist actor observations 407 and demonstration data 414. Generalist actor model 123 processes part geometries 411 and generalist actor observations 407 and generates generalist actor actions 412. Generalist loss calculator 118 uses behavior cloning loss calculator 410 to process demonstration data 414 and generalist actor actions 412 and compute behavior cloning loss 413. Model trainer 115 uses behavior cloning loss 413 to iteratively train generalist actor model 123. Once generalist actor model 123 is trained, model trainer 115 uses trained specialist actor models 122 to re-train the trained generalist actor model 123. Simulator 116 generates generalist actor observations 407. Trained generalist actor model 123 processes part geometries 411 and generalist actor observations 407 and generates generalist actor actions 412. Simulator 116 processes generalist actor actions 412 and generates specialist actor observations 406 and DAgger data 415. Trained specialist actor models 122 process specialist actor observations 406 and generate specialist actor actions 405. Generalist loss calculator 118 uses DAgger loss calculator 421 to process specialist actor actions 405 and DAgger data 415 to generate DAgger loss 420. Model trainer 115 uses DAgger loss 420 to iteratively re-train the trained generalist actor model 123. Once generalist actor model 123 is re-trained, model trainer 115 can optionally use reinforcement learning module 401 to re-train generalist actor model 123. Step 703 is described in more detail in conjunction with FIGS. 9A and 9B.

FIG. 8 is a flow diagram of method steps for training specialist actor models 122, according to various embodiments. Although the method steps are described in conjunction with the systems of FIGS. 1-5, persons skilled in the art will understand that any system configured to perform the method steps in any order falls within the scope of the present disclosure.

As shown, step 702 of the method 700 begins with step 801, where specialist reward calculator 115 receives expert assembly data 124. In various embodiments, expert assembly data 124 is received in batches, where each batch includes multiple reversed disassembly trajectories containing state-action sequences from successful executions related to a robotic assembly task.

At step 802, simulator 116 generates specialist actor observations 406. In various embodiments, simulator 116 generates specialist actor observations 406, which include at least one of the following observations: (1) the robot arm joint angles, (2) the fingertip (e.g., end-effector) pose, (3) target pose with noise, or (4) the relative transformation of the target pose with noise.

At step 803, specialist actor model 122 generates specialist actor actions 405 based on specialist actor observations 406. In various embodiments, specialist actor model 122 generates specialist actor actions 405, which include incremental pose targets (e.g., end-effector poses) in SE(3). In various embodiments, the incremental targets rather than absolute targets are chosen to select from a small, bounded spatial range.

At step 804, simulator 116 generates roll-out data 407 and critic observations 404 based on specialist actor actions 405. In various embodiments, simulator 116 generates critic observations 404, which include but are not limited to (1) the robot arm joint angles, (2) the fingertip (e.g., end-effector) pose, (3) target pose, (4) arm joint velocities, (5) fingertip (e.g., end-effector) linear velocity, (6) fingertip angular velocity, (7) plug pose, and (8) relative target pose. In various embodiments, simulator 116 can be instantiated in parallel across multiple worker processes, allowing the collection of roll-out data 407 corresponding to multiple specialist actor models 122 simultaneously. In some embodiments, since each specialist actor model 122 explores different initial poses or part configurations, simulator 116 tracks collisions, contact forces, and successful insertions, building a dataset of transition tuples (s, a, s′) included in roll-out data 407, where s is the current state (e.g., robot joint angles, the pose of the first part, and the pose of the second part), a is the specialist actor action 405, and s′ is the next state after applying a.

At step 805, specialist critic model 121 generates critic evaluations based on critic observations 404 and specialist actor actions 405. In various embodiments, each specialist critic model 121 is a parametric function V_{ϕ}:O× [symbol] → [symbol] with parameters ϕ. Given a critic observation 404 o∈O and a specialist actor action 405 a∈ [symbol] , V_{ϕ} outputs a scalar value representing the estimated expected return from that state-action pair. In some examples, \hat{Q}(o, a)=V_{ϕ} (o, a), where \hat{Q}(o, a) approximates the cumulative discounted reward that would follow when the robot continued from o with action a and thereafter acted according to the policy.

At step 806, specialist reward calculator 117 calculates reward 408 based on roll-out data 407 and expert assembly data 124. In various embodiments, specialist reward calculator 117 includes baseline reward calculator 402 and imitation reward calculator 403. Baseline reward calculator 402 calculates reward terms that penalize distance-to-goal, penalize simulation error, reward task difficulty, reward success, and/or the like. In some embodiments, baseline reward calculator 402 calculates a reward term that penalizes distance-to-goal through an SDF-based reward, which computes the distance between the current pose of the second part, such as the plug, and the goal (e.g., assembled) pose of the second part through SDF queries, which are less sensitive to object symmetries than keypoint-based distance queries. In some embodiments, baseline reward calculator 402 calculates a reward term that penalizes simulation error through a SAPU, which computes the maximum interpenetration distance at each timestep, weights the reward in inverse proportion to distance if the reward is less than a threshold, and does not update the reward otherwise. In some embodiments, baseline reward calculator 402 calculates a reward term that rewards task difficulty through an SBC, which increases the lower bound but not the upper bound of the range of initial-pose randomization as the robot becomes more proficient at the task and weights the return in proportion to task difficulty. In some embodiments, baseline reward calculator 402 calculates a reward term that rewards success with a bonus at the end of every horizon if the translational distance between the second part, such as the plug, and the goal falls below a threshold at any timestep. Imitation reward calculator 403 calculates imitation reward based on expert assembly data 124. In various embodiments, imitation reward calculator 403 calculates reward

$${R}_{t}^{{I}_{j}}$$

for a given assembly task that quantifies the instantaneous value of imitating any reversed disassembly path pᵢ′ included in expert assembly data 124. In some embodiments,

$${R}_{t}^{{I}_{i}}$$

is calculated as the distance between the assembly path the robot has already traversed, and the reversed disassembly path pᵢ′ under consideration. In some embodiments, imitation reward calculator 403 uses a distance metric between paths that is insensitive to speed or sampling rate, such as dynamic time warping (DTW) or signature transforms. Given two sequences a=[a¹, a₂, . . . , a^{P}] and b=[b¹, b², . . . , b^{Q}], DTW returns the cost C*(a, b) of the optimal matches between a and b, for example, by following Algorithm 1. In some embodiments, imitation reward calculator 403 calculates the path signature as a tensor of all possible path integrals between the coordinates, such as the calculation described in Equations 3-5. The signature transform is simply the functional T(p(t))_{a,b}:p(t)_{a,b}→S((p(t))_{a,b} that takes a path as input and outputs the path signature. In various embodiments, when imitation reward calculator 403 applies the signature transform, at each timestep t, imitation reward calculator 403 considers the full path pₑ(T)_{0,t} of the end effector from the beginning of the path. Then, for each reversed disassembly path pᵢ′ included in expert assembly data 124, imitation reward calculator 403 finds the closest point on pᵢ′ from the current point pₑ(t) on the end-effector path and extracts the segment of pᵢ′ between the start and the closest point. Imitation reward calculator 403 then calculates the path signatures S(pₑ(T))_{0,t} and S(pᵢ′) of the end-effector path and the disassembly path segment, respectively, and calculates the cost C(S(pₑ(T))_{0,t},S(pᵢ′)) between signatures, for example, as described in Equation 6. Finally, imitation reward calculator 403 calculates the reward, for example, as described in Equation 7. In some embodiments, when the reverse disassembly trajectories included in expert assembly data 124 are defined as discrete paths, signature transforms represent trajectories as collections of discrete path sums, which can quantify distances between paths even when the data is not continuous. In some embodiments, given a three-dimensional path p[n]=(x[n], y[n], z[n]) for integer steps n∈[A, N], the discrete-time path signature can be computed following Equations 8-9. In various embodiments, imitation reward calculator 403 applies the discrete signature transform at each timestep t to the entire end-effector path pₑ[t] observed so far. In general, the i th level of the discrete-time path signature includes 34 path summations, capturing increasingly rich features of the reverse disassembly trajectory. The full discrete-time path signature can thus be written as described in Equation 10. For each reversed disassembly path pᵢ′ from expert assembly data 124, imitation reward calculator 403 finds the segment of pᵢ′ closest to pₑ[t] and calculates the cost, for example, as described by Equation 10. The imitation reward for demonstration i is then defined as in Equation 11. In some embodiments, imitation reward calculator 403 applies a discrete path signature at every timestep, then uses a fast, GPU-based signature transform, such as Signatory, to compute similarity metrics between the current end-effector path and reversed disassembly paths included in expert assembly data 124. In some embodiments, imitation reward Rₜ^{I} is defined as the maximum per-timestep imitation reward over all reversed disassembly paths i=1, . . . , M included in expert assembly data 124, as described in Equation 12. In various embodiments, specialist reward calculator 117 uses baseline reward and imitation reward to calculate reward 408. In some examples, specialist reward calculator 117 calculates reward 408 using Equation 13.

At step 807, reinforcement learning module 401 updates specialist actor model 122 and specialist critic model 121 based on reward 408 and critic evaluations. In various embodiments, reinforcement learning module 401 processes reward 408 and critic evaluations to iteratively update the one or more parameters of specialist critic models 121 and specialist actor models 122. In various embodiments, the robotic assembly problem is formulated as an MDP, where the agent is a simulated robot, and the environment is a simulated environment containing the parts to be assembled. In some embodiments, reinforcement learning module 401 uses a randomized initial state distribution po and reward function R: [symbol] → [symbol] with discount factor γ∈(0,1]. Reinforcement learning module 401 constrains each agent to execute actions over episodes of length N timesteps and defines shorter learning horizons of length T timesteps. Reinforcement learning module 401 defines a total return G as described by Equation 14, which is the total return in terms of the expected sum of discounted rewards over the horizon. For example, the total return over each horizon can be given as described in Equation 15. The objective of reinforcement learning module 401 is to train policies π: [symbol] → [symbol] ( [symbol] ), mapping specialist actor observations 406 to a probability distribution over specialist actor actions 405, that maximizes the total return as given in Equation 14. In some embodiments, reinforcement learning module 401 uses various optimization algorithms including, but not limited to, the PPO algorithm to train specialist actor models 122 and specialist critic models 121. In some embodiments, reinforcement learning module 401 mitigates the low sample efficiency of PPO by using GPU-accelerated SDF-based contact simulation and a GPU-accelerated PPO implementation. In some embodiments, reinforcement learning module 401 uses PPO to learn a stochastic policy π_{θ} (e.g., specialist actor model 122) parameterized by a neural network with weights θ, as well as an approximation of the on-policy value function V_{ϕ}: [symbol] → [symbol] (e.g., specialist critic model 121) parameterized by a neural network with weights ϕ. In various embodiments, at evaluation and deployment time, policy π_{θ} is deterministic, and V_{ϕ} is neglected.

At step 808, model trainer 115 checks whether to continue training. In various embodiments, model trainer 115 trains specialist actor model 122 and specialist critic model 121 until a stopping criterion is met. For example, model trainer 115 can stop training once a maximum number of iterations or episodes has been reached. In some embodiments, model trainer 115 stops training when a performance threshold is met, such as achieving a desired insertion success rate, minimizing a distance-to-goal metric, maintaining low interpenetration with the socket for a set number of trials, and/or the like. In some embodiments, model trainer 115 stops training whenever the performance of policy π_{θ} plateaus or begins to degrade over multiple iterations. If model trainer 115 determines to continue training, method 700 returns to step 803. If model trainer 115 determines not to continue training, method 700 proceeds to step 809.

At step 809, model trainer 115 stores specialist actor model 122. In various embodiments, once model trainer 115 trains specialist actor model 122, model trainer 115 stores the trained specialist actor model 122 in datastore 120 or elsewhere.

At step 810, model trainer 115 checks whether specialist actor models 122 are trained for all assembly tasks. If model trainer 115 determines specialist actor models 122 are not trained for all assembly tasks, method 700 returns to step 801 to receive expert assembly data 124 related to a new assembly task. If model trainer 115 determines specialist actor models 122 are not trained for all assembly tasks, then method 700 proceeds to step 703.

FIG. 9A-9B are flow diagrams of method steps for training a generalist actor model 123 using trained specialist actor models 122, according to various embodiments. Although the method steps are described in conjunction with the systems of FIGS. 1-5, persons skilled in the art will understand that any system configured to perform the method steps in any order falls within the scope of the present disclosure.

As shown, step 703 of the method 700 begins with step 901, where the trained specialist actor models 122 generate specialist actor actions 405 based on specialist actor observations 405. In various embodiments, simulator 116 generates specialist actor observations 405. The trained specialist actor models 122 process specialist actor observations 405 and generate specialist actor actions 405.

At step 902, simulator 116 generates demonstration data 414 based on specialist actor actions 405. In various embodiments, simulator 116 executes each trained specialist policy Its mapping specialist actor observations 406 to specialist actor actions 405 under initial-pose randomization and generate specialist actor observations 406 until completing a fixed number (e.g., 5000) of successful episodes. For each successful episode, simulator 116 generates the state-action pairs as a demonstration

$${D}_{i} = \{ ( {s}_{i}^{1} , {a}_{i}^{1} ) , ( {s}_{i}^{2} , {a}_{i}^{2} ) , … , ( {s}_{i}^{{N}_{i}} , {a}_{i}^{{N}_{i}} ) \}$$

At step 903, simulator 116 generates generalist actor observations 407 based on demonstration data 414. In various embodiments, simulator 116 generates generalist action observations 407 based on the states

$${s}_{i}^{1} , {s}_{i}^{2} , … , {s}_{i}^{{N}_{i}}$$

included in demonstration data 414.

At step 904, generalist actor model 123 generates generalist actor actions 412 based on part geometries 411 and generalist actor observations 407. In various embodiments, generalist actor model 123 includes a pretrained neural network to extract a latent representation of part geometries 411 and generate a latent vector. In some embodiments, the pretrained neural network includes an autoencoder, which is trained on a large set of meshes M. Each mesh mᵢ∈M consists of (Vᵢ, Eᵢ), where V are the vertices and E are the (undirected) edges. During pretraining, at each iteration, a batch of meshes B⊂M are sampled. For each mᵢ∈B, a point cloud Pᵢ is sampled online, with each point

$${p}_{i}^{j}$$

∈Pᵢ lying on the surface of mᵢ. The point cloud Pᵢ is passed to an encoder, such as a PointNet encoder, to generate a latent vector zᵢ. Vector zᵢ is passed to a fully-convolutional decoder to generate a reconstructed point cloud Qᵢ. The pretrained network is trained to minimize reconstruction loss, for example, defined as the chamfer distance between Pᵢ and Qᵢ as described in Equation 16. In some embodiments, the mean and variance of the vertices Vᵢ for each mesh mᵢ prior to pretraining are normalized, such that the network is not biased by a non-uniform distribution of mesh sizes. In some embodiments, the depth of the encoder relative to the decoder is increased, such that the encoder can learn a more abstract latent representation, whereas the decoder is discouraged from overfitting to the input data. In some embodiments, the autoencoder is trained with explicit or implicit surface information, which may improve the success rate of the generalist policy, such as by augmenting each point

$${p}_{i}^{3}$$

with the local surface normal, using a graph neural net (e.g., a graph convolutional network) that takes both points and edges as input, learning low-dimensional SDF representations of the parts, and/or the like. In various embodiments, for a given assembly task, the latent vectors for the second part zₚ and the first part zₛ are concatenated before processing.

At step 905, generalist loss calculator 118 calculates behavior cloning loss 413 based on demonstration data 414 and generalist actor actions 412. In various embodiments, generalist loss calculator 118 uses behavior cloning loss calculator 410 to calculate behavior cloning loss 413. In some examples, behavior cloning loss calculator 410 calculates behavior cloning loss 413 as described in Equation 17.

At step 906, model trainer 115 updates generalist actor model 123 based on behavior cloning loss 413. In various embodiments, model trainer 412 initializes parameters of generalist policy (e.g., generalist actor model 123) π_{g} randomly. In various embodiments, at every training epoch, model trainer 115 samples batches of demonstration data 414. For each batch, model trainer 115 uses various optimization approaches, such as stochastic gradient descent, Adam, and/or the like, to update one or more parameters of generalist actor model 123 so that the behavior cloning loss 413 is minimized.

At step 907, model trainer 115 checks whether to continue training. In some embodiments, training terminates once a predefined number of epochs has been reached (e.g., 1,000 epochs). In other embodiments, training stops when the behavior cloning loss 413 fails to improve by a minimum threshold over a certain window of epochs, indicating that the model parameters have converged. In some embodiments, model trainer 115 uses a validation metric, such as the success rate of assembly tasks in a small test set, to trigger early termination of training when the validation metric reaches or surpasses a target value. If model trainer 115 determines to continue training, method 700 returns to step 903. If model trainer 115 determines not to continue training, method 700 proceeds to step 908.

At step 908, model trainer 115 stores trained generalist actor model 123. In various embodiments, model trainer 115 stores the trained generalist actor model 123 in data store 120 or elsewhere.

At step 909, the trained generalist actor model 124 generates generalist actor actions 412 based on part geometries 411 and generalist actor observations 407. In various embodiments, the generalist actor model 124 trained at step 702 of the method 700 is used to process part geometries 411 and generalist actor observations 407 and generate generalist actor actions 412.

At step 910, simulator 116 generates specialist actor observations 406 and DAgger data 415 based on generalist actor actions 412. In various embodiments, simulator 116 processes generalist actor actions 412 generated by the trained generalist actor model 123 to generate specialist actor observations 406 and DAgger data 415. In various embodiments, simulator 116 executes each trained generalist policy π_{g} mapping generalist actor observations 407 to generalist actor actions 412 and generates generalist actor observations 407, specialist actor observations 406, and DAgger data 415 until completing a fixed number (e.g., 256) of successful episodes. For each successful episode, simulator 116 generates the state-action pairs

$$\{ ( {s}_{i}^{j} , {a}_{i}^{j} ) \}$$

included in DAgger data 415, where

$${s}_{i}^{j}$$

is the state visited by trained generalist actor model 123, and

$${a}_{i}^{j} = {π}_{s} ( {s}_{i}^{j} )$$

is the corresponding specialist actor action 405.

At step 911, trained specialist actor models 122 generate specialist actor actions 412 based on specialist actor observations 406. In various embodiments, specialist actor models 122 trained at step 702 of method 700 are used to process specialist actor observations 406 and generate specialist actor actions 405.

At step 912, generalist loss calculator 118 calculates DAgger loss 420 based on DAgger data 415 and specialist actor actions 405. In various embodiments, generalist loss calculator 118 uses DAgger loss calculator 421 to process DAgger data 415 and specialist actor actions 405 and generate DAgger loss 420. In some examples, DAgger loss calculator 415 calculates DAgger loss 420 as described in Equation 18.

At step 913, model trainer 115 updates trained generalist actor model 123 based on DAgger loss 420. In various embodiments, model trainer 115 re-trains generalist actor model 123 based on DAgger loss 415. In various embodiments, at every training epoch, model trainer 115 samples batches of DAgger data 415. For each batch, model trainer 115 uses various optimization approaches, such as stochastic gradient descent, Adam, and/or the like, to update one or more parameters of the trained generalist actor model 123 so that the DAgger loss 415 is minimized.

At step 914, model trainer 115 checks whether to continue training. In some embodiments, training terminates once a predefined number of epochs has been reached. In other embodiments, training stops when the DAgger loss 415 fails to improve by a minimum threshold over a certain window of epochs, indicating that the model parameters have converged. In some embodiments, model trainer 115 uses a validation metric, such as the success rate of assembly tasks in a small test set, to trigger early termination of training when the validation metric reaches or surpasses a target value. If model trainer 115 determines to continue training, method 700 returns to step 908. If model trainer 115 determines to continue training, method 700 returns to step 908. If model trainer 115 determines not to continue training, method 700 proceeds to step 914.

At optional step 915, model trainer 115 fine-tunes retrained generalist actor model 123 using reinforcement learning. In some embodiments, once generalist actor model 123 is re-trained, model trainer 115 optionally re-trains generalist actor model 123 using reinforcement learning module 401. In some embodiments, reinforcement learning module 401 begins the re-training with the re-trained generalist actor model 123 π_{g}′ and follows a baseline reinforcement learning procedure, such as with the total return over each horizon described in Equations 14 and 15. In some embodiments, model trainer 115 uses an SBC, where the agent (e.g., the retrained generalist actor model 123) is exposed to the full range of initial-pose randomization at the start of the curriculum, but increases the lower bound at each stage. In some examples, at each curriculum stage k=1, . . . , K, the initial height of the second part (e.g., the plug) is sampled from a uniform distribution

$${h}_{k}^{i n i t} ∼ U [ {h}_{k}^{min} , {h}^{max} ] ,$$

where

$${h}_{k}^{min} < {h}_{max} , {h}_{1}^{init} \leq {h}_{k}^{init} \leq {h}_{K}^{init} ,$$

and h^{max} remains constant.

At step 916, model trainer 115 stores retrained generalist actor model 123. In various embodiments, model trainer 115 stores the retrained generalist actor model 123 in data store 120 or elsewhere.

FIG. 10 is the flow diagram of method steps for controlling a robot 160 using a trained generalist actor model 123, according to various embodiments. Although the method steps are described in conjunction with the systems of FIGS. 1-5, persons skilled in the art will understand that any system configured to perform the method steps in any order falls within the scope of the present disclosure.

As shown, a method 1000 begins with step 1001, where robot control application 146 receives sensor data 502 and part geometries 500. In various embodiments, sensor data 502 is received from one or more sensors 180 integrated into robot 160, such as RGB cameras, depth cameras, LiDAR, force/torque sensors, and/or joint encoders. Part geometries 500 can be received from multiple sources, such as preloaded CAD models, real-time object scanning, or external databases.

At step 1002, sensor data processing module 501 generates processed sensor data based on sensor data 502. In some embodiments, sensor data processing module 501 includes a pose estimation pipeline that processes an RGB-D image of parts, intrinsics matrix of a camera included in sensors 180, and extrinsics matrix of the camera, and a CAD model of the parts, and generates the 6-dimensional pose of the parts included in generalist actor observations 407. In some examples, the camera is used to capture a 1280×720 RGB image and 1280×720 depth image of a part with a known CAD model. The RGB image is shown to a user, and the user can provide one or more inputs, such as mouse clicks, natural language, and/or the like, to select the part to provide a positive annotation (e.g., a pixel that lies on the part of interest). In some embodiments, sensor data processing module 501 includes a segmentation algorithm which processes the RGB image of the part, pixel location(s), and annotation(s) and generates a segmentation mask for the part. In some examples, whenever the mask does not span the part, the user can optionally provide another positive annotation. Whenever the mask includes background features, the user can provide a negative annotation (e.g., a pixel that does not correspond to the part). The segmentation algorithm is then executed to generate additional annotation. In some embodiments, sensor data processing module 501 includes a model-based estimation algorithm, which processes the RGB image, the depth image, camera intrinsics, segmentation mask, and part CAD model and generates the 6-dimensional object pose in the camera frame. In some embodiments, sensor data processing module 501 combines the 6-dimensional object pose in the camera frame with the camera extrinsics to compute the 6D object pose in the robot frame.

At step 1003, robot control application 146 generates, using trained generalist actor model 123, generalist actor actions 412 to perform at least part of a robotic assembly task. In various embodiments, robot control application 146 uses the generalist actor model 123 trained at step 703 of the method 700 to process generalist actor observations 407 and part geometries 500 and generate generalist actor actions 412. In various embodiments, generalist actor model 123 includes a pretrained neural network, such as an autoencoder, to extract a latent representation of part geometries 411 and generate a latent vector.

At step 1004, robot control application 146 generates controls for robot 160 to perform based on the action to perform at least part of a robotic assembly task. In some embodiments, robot control application 146 includes a task-space impedance controller that processes generalist actor actions 412 and generates one or more controls. In some examples, the task-space impedance controller computes joint torques t using the relationship described in Equation 19. In some embodiments, robot control application 146 includes a superimposed nullspace controller to softly enforce a constraint on the configuration of robot 160, permitting high manipulability and mitigating undesirable effects, such as elbow drift.

At step 1005, robot control application 146 causes robot 160 to move based on controls. In various embodiments, one or more controls, such as joint torques, are applied to actuators of robot 160 to cause movements.

In sum, techniques are disclosed for robot assembly using trained specialist and generalist policy model. In various embodiments, an expert assembly data generator processes part geometry data and generates expert assembly data for training the specialist policy models, and the trained specialist policies and (optionally) reinforcement learning are used to train the generalist policy model. The expert assembly data generator includes a part geometry data preparation module, an environment randomization module, a grasp sampling module, a disassembly trajectory generator, a trajectory reversion module, and a simulator. In order to generate the expert assembly data, the part geometry data preparation module processes part geometry data, which includes but is not limited to the meshes of multiple parts that are to be assembled, and the part geometry data preparation module generates prepared part geometry data. A grasp sampling module processes the prepared part geometry data and interacts with the simulator and generates a grasp sample, which includes a feasible way for the robot end effector to grasp a part. The environment randomization module processes the grasp sample and interacts with the simulator and generates a randomized assembly state. The simulator uses a robot model and a simulation environment to simulate a robotic disassembly task based on the randomized assembly state. A disassembly trajectory generator generates one or more disassembly trajectories, which include robot trajectories on how the robot disassembles the grasped part from another part, based on the grasp sample and the randomized assembly state in the simulator. Then, a trajectory reversion module reverses the disassembly trajectories.

In some embodiments, the expert assembly data is used to train specialist actor models, which are machine learning models trained to control a robot to perform specific robotic assembly tasks, that are in turn used to train a generalist actor model, which is a machine learning model that is trained to control a robot to perform multiple different robotic assembly tasks. The training is carried out in three stages. In the first stage of training, the simulator generates one or more specialist actor model observations. The specialist actor models process the specialist actor observations and generate specialist actor actions, which are applied to the simulator to generate new actor observations and critic observations. Specialist critic models, which are machine learning models, evaluate the specialist actor actions using the critic observations and generate critic evaluations. The simulator then generates roll-out data, which includes robot and parts states as well as specialist actor observations. A specialist reward calculator calculates a reward that includes a baseline reward and an imitation reward based on the roll-out data and expert assembly data. A reinforcement learning module then updates one or more parameters of the specialist actor models and specialist critic models based on the reward and specialist critic evaluations iteratively, until a stopping criterion is met. Once the specialist actor models are trained, the model trainer stores the trained specialist actor models to be used in the second stage. In the second stage of training, the trained specialist actor models process specialist actor observations from the simulator and generate specialist actor actions. The simulator processes the specialist actor actions and generates demonstration data. The simulator then generates generalist actor actions based on the demonstration data. The generalist actor model processes part geometries and the generalist actor observations and generate generalist actor actions. A generalist loss calculator calculates a behavior cloning loss based on a difference between the specialist actor actions included in expert demonstration data and the generalist actor actions. The model trainer uses the behavior cloning loss to update one or more parameters of the generalist actor model until a stopping criterion is met. Once the training of the generalist actor model during the second stage is complete, the model trainer stores the trained generalist actor model to be re-trained in the third stage. In the third stage of the training, the trained generalist actor model processes generalist actor observations from the simulator to generate generalist actor actions. The simulator uses the generalist actor actions to generate specialist actor observations and (dataset aggregation) DAgger data. The trained specialist actor models process the specialist actor observations and generate specialist actor actions. The generalist loss calculator processes the specialist actor actions and the DAgger data to calculate a DAgger loss. The model trainer uses the DAgger loss to update one or more parameters of the trained generalist actor model iteratively until a stopping criterion is met. In some embodiments, the model trainer optionally further re-trains the trained generalist actor model using reinforcement learning. Subsequent to training, the trained generalist actor model can be used to process part geometries and sensor data to generate actions for controlling a robot to perform at least part of a robotic assembly task.

At least one technical advantage of the disclosed techniques relative to the prior art is that the disclosed techniques enable robotic assembly in high-mixture settings where a robot is required to assemble many different types of parts, each potentially varying in shape, size, and orientation, and the disclosed techniques do not require customized fixtures, predefined tooling, or manually specified waypoints. Additionally, the disclosed techniques allow robots to dynamically adjust movements based on real-time part observations rather than adhering to rigid pre-programmed waypoints. The ability to adjust movements based on real-time part observations enables a single robotic assembly system to adapt to various product models and parts variations within the same production line, improving efficiency and reducing downtime associated with reconfiguring the robotic assembly system. These technical advantages provide one or more technological improvements over prior art approaches.

1. In some embodiments, a computer-implemented method for training a robot control model comprises generating, using one or more simulations, a plurality of disassembly trajectories along which a first part is disassembled from a second part, reversing the plurality of disassembly trajectories to generate a plurality of reversed disassembly trajectories, and performing, based on the plurality of reversed disassembly trajectories, one or more operations to train an untrained machine learning model to generate a trained machine learning model, wherein the trained machine learning model is trained to control a robot to assemble the first part and the second part.

2. The computer-implemented method of clause 1, further comprising determining, based on the first part, the second part, and the robot, a grasp pose with which the robot can grasp the first part, and generating, based on the grasp pose, a randomized state of the first part, the second part, and the robot, wherein, during the one or more simulations, the robot grasps the first part using the grasp pose.

3. The computer-implemented method of clauses 1 or 2, wherein generating the randomized state comprises generating, based on first geometry associated with the first part and second geometry associated with the second part, prepared geometry data for the first part and the second part to include in the randomized state, and generating, based on the prepared geometry data for the first part and the second part, the grasp pose.

4. The computer-implemented method of any of clauses 1-3, wherein generating the randomized state comprises generating a randomized robot gripper state of a gripper of the robot, generating a randomized first part state of the first part, generating, based on the randomized first part state and the randomized robot gripper state, a randomized second part state of the second part, and generating, based on the randomized first part state, the randomized second part state, and the randomized robot gripper state, the randomized state.

5. The computer-implemented method of any of clauses 1-4, further comprising generating a grasp pose with which the robot grasps the first part, wherein generating the grasp pose comprises determining one or more candidate grasp poses for the first part, and selecting the grasp pose from the one or more candidate grasp poses based on a physics-based evaluation.

6. The computer-implemented method of any of clauses 1-5, wherein determining one or more candidate grasp poses for the first part comprises generating an assembled state of a first geometry associated with the first part, a second geometry associated with the second part, and a third geometry associated with a gripper of the robot, sampling a surface normal on the second geometry, aligning a central axis of the third geometry to be collinear with the surface normal, sampling a position along the surface normal, translating the third geometry to the position along the surface normal, and generating, based on the third geometry, the grasp pose for the first part.

7. The computer-implemented method of any of clauses 1-6, wherein generating the grasp pose comprises rejecting at least one candidate grasp pose included in the one or more candidate grasp poses based on at least one of (i) an intersection of two or more geometries associated with the first part, the second part, and/or the robot, or (ii) a first geometry associated with a gripper of the robot being outside one or more bounds.

8. The computer-implemented method of any of clauses 1-7, where rejecting the at least one candidate grasp pose comprises at least one of rejecting the at least one candidate grasp pose in response to determining that the first geometry associated with the gripper of the robot intersects at least one of a second geometry associated with the first part or a third geometry associated with the second part, rejecting the at least one candidate grasp pose in response to determining that the third geometry does not intersect a closing region of the first geometry, or rejecting the at least one candidate grasp pose in response to determining that one or more Euler angles of the first geometry are outside of one or more predefined bounds.

9. The computer-implemented method of any of clauses 1-8, wherein performing one or more operations to train the untrained machine learning model comprises processing one or more observations and one or more geometries associated with the first part and the second part using the untrained machine learning model to generate one or more predicted robot actions, computing, based on the one or more predicted robot actions and one or more of the plurality of reversed disassembly trajectories, one or more loss values, and updating, based on the one or more loss values, one or more parameters of the untrained machine learning model.

10. The computer-implemented method of any of clauses 1-9, further comprising receiving sensor data and one or more geometries associated with one or more additional parts, processing the sensor data and the one or more geometries using the trained machine learning model to generate one or more robot actions, and controlling the robot to move based on the one or more robot actions.

11. In some embodiments, one or more non-transitory computer readable media store instructions that, when executed by one or more processors, cause the one or more processors to perform the steps of generating, using one or more simulations, a plurality of disassembly trajectories along which a first part is disassembled from a second part, reversing the plurality of disassembly trajectories to generate a plurality of reversed disassembly trajectories, and performing, based on the plurality of reversed disassembly trajectories, one or more operations to train a machine learning model to control a robot to assemble the first part and the second part to generate a trained machine learning model.

12. The one or more non-transitory computer-readable media of clause 11, wherein the instructions, when executed by the one or more processors, further cause the one or more processors to perform the step of generating a randomized state of the first part, the second part, and the robot, and determining, based on the randomized state, a grasp pose with which the robot can grasp the first part, wherein, during the one or more simulations, the robot grasps the first part using the grasp pose.

13. The one or more non-transitory computer-readable media of clauses 11 or 12, wherein generating the randomized state comprises generating, based on first geometry associated with the first part and second geometry associated with the second part, prepared geometry data for the first part and the second part to include in the randomized state, and generating, based on the prepared geometry data for the first part and the second part, the randomized state.

14. The one or more non-transitory computer-readable media of any of clauses 11-13, wherein generating the prepared geometry data for the first part and the second part comprises at least one of scaling at least one of the first geometry or the second geometry, reorienting at least one of the first geometry or the second geometry, translating at least one of the first geometry or the second geometry, shifting one or more vertices of at least one of the first geometry or the second geometry, modifying at least one of the first geometry or the second geometry based on user input, chamfering one or more contact edges of at least one of the first geometry or the second geometry, or subdividing at least one of the first geometry or the second geometry.

15. The one or more non-transitory computer readable media of any of clauses 11-14, wherein generating the randomized state comprises generating a randomized robot gripper state of a gripper of the robot, generating a randomized first part state of the first part, generating, based on the randomized first part state and the randomized robot gripper state, a randomized second part state of the second part, and generating, based on the randomized first part state, the randomized second part state, and the randomized robot gripper state, the randomized state.

16. The one or more non-transitory computer readable media of any of clauses 11-15, wherein the instructions, when executed by the one or more processors, further cause the one or more processors to perform the step of generating a grasp pose with which the robot grasps the first part, wherein generating the grasp pose comprises determining one or more candidate grasp poses for the first part, and selecting the grasp pose from the one or more candidate grasp poses based on a physics-based evaluation.

17. The one or more non-transitory computer readable media of any of clauses 11-16, wherein performing one or more operations to train the machine learning model comprises processing one or more observations and one or more geometries associated with the first part and the second part using the machine learning model to generate one or more predicted robot actions, computing, based on the one or more predicted robot actions and one or more of the plurality of reversed disassembly trajectories that are selected using at least one of a dynamic time warping or a signature transform, one or more loss values, and updating, based on the one or more loss values, one or more parameters of the machine learning model.

18. The one or more non-transitory computer readable media of any of clauses 11-17, further comprising receiving sensor data and one or more geometries associated with one or more additional parts, processing the sensor data and the one or more geometries using the trained machine learning model to generate one or more robot actions, and controlling the robot to move based on the one or more robot actions.

19. The one or more non-transitory computer readable media of any of clauses 11-18, wherein the instructions, when executed by the one or more processors, further cause the one or more processors to perform the step of determining a grasp pose with which the robot grasps the first part, wherein determining the grasp pose comprises lifting a grasped part that a gripper of the robot grasps from the second part until a first convex hull of at least one portion of the grasped part no longer intersects a second convex hull of the second part, and moving the gripper of the robot to a random pose.

20. In some embodiments, a system comprises one or more memories storing instructions, and one or more processors that are coupled to the one or more memories and, when executing the instructions, are configured to generate, using one or more simulations, a plurality of disassembly trajectories along which a first part is disassembled from a second part, reverse the plurality of disassembly trajectories to generate a plurality of reversed disassembly trajectories, and perform, based on the plurality of reversed disassembly trajectories, one or more operations to train a machine learning model to control a robot to assemble the first part and the second part to generate a trained machine learning model.

1. In some embodiments, a computer-implemented method for training a machine learning model to control a robot comprises performing, based on demonstration data associated with one or more assembly tasks, one or more first training operations to generate one or more first trained machine learning models, wherein each first trained machine learning included in the one or more first trained machine learning models is trained to control a robot to perform a different assembly task, and performing, based on the one or more first trained machine learning models and one or more geometries associated with one or more parts, one or more second training operations to generate a second trained machine learning model, wherein the second trained machine learning model is trained to control the robot to perform a plurality of assembly tasks.

2. The computer-implemented method of clause 1, wherein performing one or more training operations to generate the one or more first trained machine learning models comprises processing one or more first observations using an untrained machine learning model to generate an action, generating, based on the action and using a simulator, simulated data and one or more second observations, processing the one or more second observations and the action using an untrained evaluation model to generate one or more evaluations, calculating, based on the simulated data and the demonstration data, a reward, and updating one or more parameters of the untrained machine learning model and one or more parameters of the untrained evaluation model based on the one or more evaluations and the reward.

3. The method of clauses 1 or 2, wherein the simulated data comprises at least one of one or more joint angles of the robot or one or more poses of a part included in the one or more parts.

4. The computer-implemented method of any of clauses 1-3, wherein calculating the reward comprises calculating, based on the simulated data, a reinforcement learning reward, calculating, based on the demonstration data and the simulated data, an imitation learning reward, and calculating, based on the reinforcement learning reward and the imitation learning reward, the reward.

5. The computer-implemented method of any of clauses 1-4, wherein calculating the reward comprises using at least one of a dynamic time warping or a signature transform to measure a similarity between a simulated trajectory included in the simulated data and a demonstration trajectory included in the demonstration data.

6. The computer-implemented method of any of clauses 1-5, wherein performing one or more training operations to generate the second trained machine learning model comprises processing one or more first observations using a first trained machine learning model included in the one or more first trained machine learning models to generate one or more first robot actions, generating, based on the one or more first robot actions and using a simulator, additional demonstration data, generating, based on the additional demonstration data, one or more second observations, processing the one or more second observations and the one or more geometries using an untrained machine learning model to generate one or more second robot actions, calculating, based on the additional demonstration data and the one or more second robot actions, a first loss, and updating one or more parameters of the untrained machine learning model based on the first loss to generate a trained machine learning model.

7. The computer-implemented method of any of clauses 1-6, wherein performing one or more training operations to generate the second trained machine learning model further comprises processing the one or more second observations and the one or more geometries using the trained machine learning model to generate one or more third robot actions, generating, based on the one or more third robot actions and using the simulator, one or more third observations and data aggregation (DAgger) data, processing the one or more third observations using the trained first machine learning model to generate one or more fourth robot actions, calculating, based on the DAgger data and the one or more fourth robot actions, a second loss, and updating one or more parameters of the trained machine learning model based on the second loss.

8. The computer-implemented method of any of clauses 1-7, wherein performing one or more training operations to generate the second trained machine learning model further comprises using a sampling-based curriculum to re-train the second trained machine learning model.

9. The computer-implemented method of any of clauses 1-8, based on one or more sensor inputs, sensor data to generate processed sensor data, and processing the processed sensor data and the one or more geometries using the second trained machine learning model to generate one or more robot actions, and controlling the robot to move based on the one or more robot actions.

10. The computer-implemented method of any of clauses 1-9, wherein processing the sensor data comprises performing, based on the sensor data, at least one of one or more pose estimation operations, one or more segmentation operations, or one or more model-based estimation operations.

11. In some embodiments, one or more non-transitory computer readable media store instructions that, when executed by one or more processors, cause the one or more processors to perform the steps of performing, based on demonstration data associated with one or more assembly tasks, one or more first training operations to generate one or more first trained machine learning models, wherein each first trained machine learning included in the one or more first trained machine learning models is trained to control a robot to perform a different assembly task, and performing, based on the one or more first trained machine learning models and one or more geometries associated with one or more parts, one or more second training operations to generate a second trained machine learning model, wherein the second trained machine learning model is trained to control the robot to perform a plurality of assembly tasks.

12. The one or more non-transitory computer-readable media of clause 11, wherein performing one or more training operations to generate the one or more first trained machine learning models comprises processing one or more first observations using an untrained machine learning model to generate an action, generating, based on the action and using a simulator, simulated data and one or more second observations, processing the one or more second observations and the action using an untrained evaluation model to generate one or more evaluations, calculating, based on the simulated data and the demonstration data, a reward, and updating one or more parameters of the untrained machine learning model and one or more parameters of the untrained evaluation model based on the one or more evaluations and the reward.

13. The one or more non-transitory computer-readable media of clauses 11 or 12, wherein calculating the reward comprises calculating, based on the simulated data, a reinforcement learning reward, calculating, based on the demonstration data and the simulated data, an imitation learning reward, and calculating, based on the reinforcement learning reward and the imitation learning reward, the reward.

14. The one or more non-transitory computer-readable media of any of clauses 11-13, wherein calculating the reward comprises calculating a simulation error reward using a simulation-aware policy update (SAPU) that measures a maximum interpenetration distance at a timestep, in response to determining that the simulation error reward is less than a threshold, applying a weight to the simulation error reward in inverse proportion to the maximum interpenetration distance, and in response to determining that the simulation reward is not less than the threshold, not updating the simulation error reward.

15. The one or more non-transitory computer-readable media of any of clauses 11-14, wherein performing one or more training operations to generate the second trained machine learning model comprises processing one or more first observations using a first trained machine learning model included in the one or more first trained machine learning models to generate one or more first robot actions, generating, based on the one or more first robot actions and using a simulator, additional demonstration data, generating, based on the additional demonstration data, one or more second observations, processing the one or more second observations and the one or more geometries using an untrained machine learning model to generate one or more second robot actions, calculating, based on the additional demonstration data and the one or more second robot actions, a first loss, and updating one or more parameters of the untrained machine learning model based on the first loss to generate a trained machine learning model.

16. The one or more non-transitory computer-readable media of any of clauses 11-15, wherein performing one or more training operations to generate the second trained machine learning model further comprises processing the one or more second observations and the one or more geometries using the trained machine learning model to generate one or more third robot actions, generating, based on the one or more third robot actions and using the simulator, one or more third observations and data aggregation (DAgger) data, processing the one or more third observations using the trained first machine learning model to generate one or more fourth robot actions, calculating, based on the DAgger data and the one or more fourth robot actions, a second loss, and updating one or more parameters of the trained machine learning model based on the second loss.

17. The one or more non-transitory computer-readable media of any of clauses 11-16, wherein the demonstration data comprises a plurality of reversed disassembly trajectories associated with the one or more assembly tasks.

18. The one or more non-transitory computer-readable media of any of clauses 11-17, wherein the instructions, when executed by the one or more processors, further cause the one or more processors to perform the steps of processing, based on one or more sensor inputs, sensor data to generate processed sensor data, and processing the processed sensor data and the one or more geometries using the second trained machine learning model to generate one or more robot actions, and controlling the robot to move based on the one or more robot actions.

19. The one or more non-transitory computer-readable media of any of clauses 11-18, wherein processing the processed sensor data and the one or more geometries using the trained machine learning model comprises generating a latent vector, based on the one or more geometries, using a trained autoencoder.

20. In some embodiments, a system comprises one or more memories storing instructions, and one or more processors that are coupled to the one or more memories and, when executing the instructions, are configured to perform, based on demonstration data associated with one or more assembly tasks, one or more first training operations to generate one or more first trained machine learning models, wherein each first trained machine learning included in the one or more first trained machine learning models is trained to control a robot to perform a different assembly task, and perform, based on the one or more first trained machine learning models and one or more geometries associated with one or more parts, one or more second training operations to generate a second trained machine learning model, wherein the second trained machine learning model is trained to control the robot to perform a plurality of assembly tasks.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for training a robot control model, the method comprising:
generating, using one or more simulations, a plurality of disassembly trajectories along which a first part is disassembled from a second part;
reversing the plurality of disassembly trajectories to generate a plurality of reversed disassembly trajectories; and
performing, based on the plurality of reversed disassembly trajectories, one or more operations to train an untrained machine learning model to generate a trained machine learning model, wherein the trained machine learning model is trained to control a robot to assemble the first part and the second part.

2. The computer-implemented method of claim 1, further comprising:
determining, based on the first part, the second part, and the robot, a grasp pose with which the robot can grasp the first part; and
generating, based on the grasp pose, a randomized state of the first part, the second part, and the robot,
wherein, during the one or more simulations, the robot grasps the first part using the grasp pose.

3. The computer-implemented method of claim 2, wherein generating the randomized state comprises:
generating, based on first geometry associated with the first part and second geometry associated with the second part, prepared geometry data for the first part and the second part to include in the randomized state; and
generating, based on the prepared geometry data for the first part and the second part, the grasp pose.

4. The computer-implemented method of claim 2, wherein generating the randomized state comprises:
generating a randomized robot gripper state of a gripper of the robot;
generating a randomized first part state of the first part;
generating, based on the randomized first part state and the randomized robot gripper state, a randomized second part state of the second part; and
generating, based on the randomized first part state, the randomized second part state, and the randomized robot gripper state, the randomized state.

5. The computer-implemented method of claim 1, further comprising generating a grasp pose with which the robot grasps the first part, wherein generating the grasp pose comprises:
determining one or more candidate grasp poses for the first part; and
selecting the grasp pose from the one or more candidate grasp poses based on a physics-based evaluation.

6. The computer-implemented method of claim 5, wherein determining one or more candidate grasp poses for the first part comprises:
generating an assembled state of a first geometry associated with the first part, a second geometry associated with the second part, and a third geometry associated with a gripper of the robot;
sampling a surface normal on the second geometry;
aligning a central axis of the third geometry to be collinear with the surface normal;
sampling a position along the surface normal;
translating the third geometry to the position along the surface normal; and
generating, based on the third geometry, the grasp pose for the first part.

7. The computer-implemented method of claim 5, wherein generating the grasp pose comprises rejecting at least one candidate grasp pose included in the one or more candidate grasp poses based on at least one of (i) an intersection of two or more geometries associated with the first part, the second part, and/or the robot, or (ii) a first geometry associated with a gripper of the robot being outside one or more bounds.

8. The computer-implemented method of claim 7, where rejecting the at least one candidate grasp pose comprises at least one of:
rejecting the at least one candidate grasp pose in response to determining that the first geometry associated with the gripper of the robot intersects at least one of a second geometry associated with the first part or a third geometry associated with the second part;
rejecting the at least one candidate grasp pose in response to determining that the third geometry does not intersect a closing region of the first geometry; or
rejecting the at least one candidate grasp pose in response to determining that one or more Euler angles of the first geometry are outside of one or more predefined bounds.

9. The computer-implemented method of claim 1, wherein performing one or more operations to train the untrained machine learning model comprises:
processing one or more observations and one or more geometries associated with the first part and the second part using the untrained machine learning model to generate one or more predicted robot actions;
computing, based on the one or more predicted robot actions and one or more of the plurality of reversed disassembly trajectories, one or more loss values; and
updating, based on the one or more loss values, one or more parameters of the untrained machine learning model.

10. The computer-implemented method of claim 1, further comprising:
receiving sensor data and one or more geometries associated with one or more additional parts;
processing the sensor data and the one or more geometries using the trained machine learning model to generate one or more robot actions; and
controlling the robot to move based on the one or more robot actions.

11. One or more non-transitory computer readable media storing instructions that, when executed by one or more processors, cause the one or more processors to perform the steps of:
generating, using one or more simulations, a plurality of disassembly trajectories along which a first part is disassembled from a second part;
reversing the plurality of disassembly trajectories to generate a plurality of reversed disassembly trajectories; and
performing, based on the plurality of reversed disassembly trajectories, one or more operations to train a machine learning model to control a robot to assemble the first part and the second part to generate a trained machine learning model.

12. The one or more non-transitory computer-readable media of claim 11, wherein the instructions, when executed by the one or more processors, further cause the one or more processors to perform the step of:
generating a randomized state of the first part, the second part, and the robot; and
determining, based on the randomized state, a grasp pose with which the robot can grasp the first part,
wherein, during the one or more simulations, the robot grasps the first part using the grasp pose.

13. The one or more non-transitory computer-readable media of claim 12, wherein generating the randomized state comprises:
generating, based on first geometry associated with the first part and second geometry associated with the second part, prepared geometry data for the first part and the second part to include in the randomized state; and
generating, based on the prepared geometry data for the first part and the second part, the randomized state.

14. The one or more non-transitory computer-readable media of claim 13, wherein generating the prepared geometry data for the first part and the second part comprises at least one of:
scaling at least one of the first geometry or the second geometry;
reorienting at least one of the first geometry or the second geometry;
translating at least one of the first geometry or the second geometry;
shifting one or more vertices of at least one of the first geometry or the second geometry;
modifying at least one of the first geometry or the second geometry based on user input;
chamfering one or more contact edges of at least one of the first geometry or the second geometry; or
subdividing at least one of the first geometry or the second geometry.

15. The one or more non-transitory computer readable media of claim 12, wherein generating the randomized state comprises:
generating a randomized robot gripper state of a gripper of the robot;
generating a randomized first part state of the first part;
generating, based on the randomized first part state and the randomized robot gripper state, a randomized second part state of the second part; and
generating, based on the randomized first part state, the randomized second part state, and the randomized robot gripper state, the randomized state.

16. The one or more non-transitory computer readable media of claim 11, wherein the instructions, when executed by the one or more processors, further cause the one or more processors to perform the step of generating a grasp pose with which the robot grasps the first part, wherein generating the grasp pose comprises:
determining one or more candidate grasp poses for the first part; and
selecting the grasp pose from the one or more candidate grasp poses based on a physics-based evaluation.

17. The one or more non-transitory computer readable media of claim 11, wherein performing one or more operations to train the machine learning model comprises:
processing one or more observations and one or more geometries associated with the first part and the second part using the machine learning model to generate one or more predicted robot actions;
computing, based on the one or more predicted robot actions and one or more of the plurality of reversed disassembly trajectories that are selected using at least one of a dynamic time warping or a signature transform, one or more loss values; and
updating, based on the one or more loss values, one or more parameters of the machine learning model.

18. The one or more non-transitory computer readable media of claim 11, further comprising:
receiving sensor data and one or more geometries associated with one or more additional parts;
processing the sensor data and the one or more geometries using the trained machine learning model to generate one or more robot actions; and
controlling the robot to move based on the one or more robot actions.

19. The one or more non-transitory computer readable media of claim 11, wherein the instructions, when executed by the one or more processors, further cause the one or more processors to perform the step of determining a grasp pose with which the robot grasps the first part, wherein determining the grasp pose comprises:
lifting a grasped part that a gripper of the robot grasps from the second part until a first convex hull of at least one portion of the grasped part no longer intersects a second convex hull of the second part; and
moving the gripper of the robot to a random pose.

20. A system comprising:
one or more memories storing instructions, and
one or more processors that are coupled to the one or more memories and, when executing the instructions, are configured to:
generate, using one or more simulations, a plurality of disassembly trajectories along which a first part is disassembled from a second part,
reverse the plurality of disassembly trajectories to generate a plurality of reversed disassembly trajectories, and
perform, based on the plurality of reversed disassembly trajectories, one or more operations to train a machine learning model to control a robot to assemble the first part and the second part to generate a trained machine learning model.
